(19) United States
(12) Patent Application Publication
(10) Pub. No.: US 2020/0067709 A1
(43) Pub. Date: Feb. 27, 2020

(54) METHODS, APPARATUSES, AND COMPUTER PROGRAM PRODUCTS FOR FRICTIONLESSCUSTODY CHAIN MANAGEMENT

(71) Applicant: Averon US, Inc., Henderson, NV (US)

(72) Inventors: Wendell BROWN, Henderson, NV (US); Mark HERSCHBERG, Henderson, NV (US)

(21) Appl. No.: 16/549,662

(22) Filed: Aug. 23, 2019

Related U.S. Application Data
(60) Provisional application No. 62/721,944, filed on Aug. 23, 2018.

(51) Int. Cl. H04L 9/32; H04L 9/06

(52) U.S. Cl. CPC H04L 9/321; H04L 9/3231; H04L 9/0637; H04L 9/3265

(57) ABSTRACT

Various embodiments of the present disclosure are directed to managing frictionless custody chain management. In an example context, the custody chain is formed of transfer records summarizing transfers of a transfer item between various users authenticated using a secure, trusted third-party verifiable process. Embodiments provided include an apparatus configured to receive a custody transfer request data object including transfer request information, identify device identification information, associate the device identification information with at least a transfer item data object to identify an associated transfer information set, and store a transfer record based on the associated information set. The apparatus may authenticate the received information or corresponding information, user identities, and/or the like, using various authentication processes, including trusted third-party verifiable process(es). Other embodiments provided include an apparatus configured to generate and transmit the custody transfer request data object.

### CROSS-REFERENCE TO RELATED APPLICATIONS

This application claims priority to U.S. Provisional Application No. 62/721,944 filed Aug. 23, 2019, the content of which is incorporated herein by reference in its entirety.

### TECHNOLOGICAL FIELD

Embodiments of the present disclosure generally relate to managing chain of custody information, and specifically, to improved systems, apparatuses, methods, and computer program products for frictionless custody chain management.

### BACKGROUND

In various environments, various objects change hands between users for various reasons. Such reasons include sales, gifting, donations, information dissemination, and other transactions, as well as electronic transfers of goods and/or information. Tracking such transfers can be difficult, a user's identity may not be readily verifiable. In some contexts, even if the identity of a user is verifiable, it is often difficult or impossible to determine if a transferor of an object is transferring an object they have permission to transfer. Conventional methods for tracking such transfers require manual tracking and record keeping of signatures or other verification information as one or more object(s) is/are transferred, forming a conventional chain of custody. Conventional systems include cumbersome registration and authentication (and/or reauthentication) processes, severely decreasing system efficiency and usability. Applicant has discovered problems with current systems, methods, apparatuses, and computer program products for tracking object transfers, and through applied effort, ingenuity, and innovation, Applicant has solved many of these identified problems by developing a solution that is embodied in the present disclosure, which is described in detail below.

### BRIEF SUMMARY

In general, embodiments of the present disclosure provided herein include systems, methods, apparatuses and computer readable media for frictionless custody chain management. In this regard, embodiment apparatus(es) and/or system(s) may include computer-coded instructions capable of similar operations to those performed in embodiment methods. Similarly, embodiment computer program products may include program code instructions for similar operations to those performed in embodiment methods. Other systems, apparatuses, methods, computer readable media, and features will be, or will become, apparent to one with skill in the art upon examination of the following figures and detailed description. It is intended that all such additional systems, apparatuses, methods, computer readable media, and features be included within this description be within the scope of the disclosure and be protected by the following claims.

In some example embodiments, an apparatus for frictionless custody chain management is provided for. The apparatus includes at least one processor and at least one memory, the at least one memory having computer-coded instructions thereon. The computer-coded instructions are configured to cause the apparatus to receive, from a recipient client device, a custody transfer request data object comprising transfer request information; identify device identification information associated with the recipient client device; associate at least the device identification information with a transfer item data object to identify an associated transfer information set; and store, to a transfer record storage, a transfer record comprising the associated transfer information set.

Alternatively or additionally, in some embodiments of the apparatus, the device identification information associated with the recipient client device is identified from a network device associated with a trusted network provider using a header enrichment process.

Alternatively or additionally, in some embodiments of the apparatus, the custody transfer request data object further comprises device location data associated with the recipient client device, and the apparatus is further configured to identify stored proximity data associated with the recipient client device; and compare the device location data and the stored proximity data to determine whether the device location data is within a geographic region defined by the stored proximity data.

Alternatively or additionally, in some embodiments of the apparatus, the custody transfer request data object further comprises device user biometric data, and the apparatus is further configured to identify confirmed biometric data associated with the recipient client device; and compare the device user biometric data and the confirmed biometric data to determine whether the device user biometric data matches the confirmed biometric data.

Alternatively or additionally, in some embodiments of the apparatus, the transfer request information comprises a transfer item data object and transferor data object identification information associated with a transferor data object, and the apparatus is further configured to query the transfer record blockchain, based on the transfer data object, to identify a recorded possessor data object associated with the transfer item data object; receive result data including the recorded possessor data object associated with the transfer item data object; and determine the recorded possessor data object matches the transferor data object.

Alternatively or additionally, in some embodiments of the apparatus, the custody transfer request data object further comprises device location data associated with the recipient client device, and the apparatus is further configured to identify stored proximity data associated with the recipient client device; compare the device location data and the stored proximity data to determine the device location data is not within a geographic region defined by the stored proximity data; and transmit a transfer denial error to the recipient client device in response to the determination.

Alternatively or additionally, in some embodiments of the apparatus, the custody transfer request data object further comprises device user biometric data, and wherein the apparatus is configured to identify confirmed biometric data associated with the recipient client device; compare the device user biometric data and the confirmed biometric data determine the device user biometric data does not match the confirmed biometric data; and transmit a transfer denial error to the recipient client device in response to the determination.

Alternatively or additionally, in some embodiments of the apparatus, the transfer request information comprises a transfer item data object and transferor data object identification information associated with a transferor data object, and the apparatus is further configured to query the transfer record blockchain, based on the transfer data object, to identify a recorded possessor data object associated with the transfer item data object; receive result data including the recorded possessor data object associated with the transfer item data object; determine the recorded possessor data object does not match the transferor data object; and transmit a transfer denial error to the recipient client device in response to the determination.

Alternatively or additionally, in some embodiments of the apparatus, the transfer request information comprises a transferor user authentication information associated with a transferor data object, and the apparatus is further configured to authenticate the transferor user authentication information based on stored authentication information associated with the transferor data object.

Alternatively or additionally, in some embodiments of the apparatus, the associated transfer information set comprises (1) the device identification information, (2) transferor data object identification information associated with a transferor data object, (3) transfer item information associated with a transfer item data object, (4) a transfer timestamp, (5) image data associated with the transfer request information, or (6) a combination thereof.

In some other example embodiments, a computer-implemented method for frictionless custody chain management is provided. The computer-implemented method may be implementable using specially configured computing hardware, software, or a combination thereof, for example via a specially configured device. An example computer-implemented method includes receiving, from a recipient client device, a custody transfer request data object comprising transfer request information; identifying device identification information associated with the recipient client device; associating at least the device identification information with a transfer item data object to identify an associated transfer information set; and storing, to a transfer record storage, a transfer record comprising the associated transfer information set.

Alternatively or additionally, in some embodiments of the computer-implemented method, the device identification information associated with the recipient client device is identified from a network device associated with a trusted network provider using a header enrichment process.

Alternatively or additionally, in some embodiments of the computer-implemented method, the custody transfer request data object further comprises device location data associated with the recipient client device, and the method further comprises identifying stored proximity data associated with the recipient client device; and comparing the device location data and the stored proximity data to determine whether the device location data is within a geographic region defined by the stored proximity data.

Alternatively or additionally, in some embodiments of the computer-implemented method, the custody transfer request data object further comprises device user biometric data, and the method further comprises identifying confirmed biometric data associated with the recipient client device; and comparing the device user biometric data and the confirmed biometric data to determine whether the device user biometric data matches the confirmed biometric data.

Alternatively or additionally, in some embodiments of the computer-implemented method, the transfer request information comprises a transfer item data object and transferor data object identification information associated with a transferor data object, and the method further comprises querying the transfer record blockchain, based on the transfer data object, to identify a recorded possessor data object associated with the transfer item data object; receiving result data including the recorded possessor data object associated with the transfer item data object; and determining the recorded possessor data object matches the transferor data object.

Alternatively or additionally, in some embodiments of the computer-implemented method, the custody transfer request data object further comprises device location data associated with the recipient client device, and the method further comprises identifying stored proximity data associated with the recipient client device; comparing the device location data and the stored proximity data to determine the device location data is not within a geographic region defined by the stored proximity data; and transmitting a transfer denial error to the recipient client device in response to the determination.

Alternatively or additionally, in some embodiments of the computer-implemented method, the custody transfer request data object further comprises device user biometric data, and the method further comprises identifying confirmed biometric data associated with the recipient client device; comparing the device user biometric data and the confirmed biometric data determine the device user biometric data does not match the confirmed biometric data; and transmitting a transfer denial error to the recipient client device in response to the determination.

Alternatively or additionally, in some embodiments of the computer-implemented method, the transfer request information comprises a transfer item data object and transferor data object identification information associated with a transferor data object, and the method further comprises querying the transfer record blockchain, based on the transfer data object, to identify a recorded possessor data object associated with the transfer item data object; receiving result data including the recorded possessor data object associated with the transfer item data object; determining the recorded possessor data object does not match the transferor data object; and transmitting a transfer denial error to the recipient client device in response to the determination.

Alternatively or additionally, in some embodiments of the computer-implemented method, the transfer request information comprises a transferor user authentication information associated with a transferor data object, and the method further comprises authenticating the transferor user authentication information based on stored authentication information associated with the transferor data object.

Alternatively or additionally, in some embodiments of the computer-implemented method, the associated transfer information set comprises (1) the device identification information, (2) transferor data object identification information associated with a transferor data object, (3) transfer item information associated with a transfer item data object, (4) a transfer timestamp, (5) image data associated with the transfer request information, or (6) a combination thereof.

In some other example embodiments, a computer program product for frictionless custody chain management is provided. An example computer program product comprises a non-transitory computer readable storage medium having computer program instructions stored thereon. The computer program instructions, when executed by a processor, are configured for receiving, from a recipient client device, a custody transfer request data object comprising transfer request information; identifying device identification information associated with the recipient client device; associating at least the device identification information with a transfer item data object to identify an associated transfer information set; and storing, to a transfer record storage, a transfer record comprising the associated transfer information set.

Alternatively or additionally, in some embodiments of the computer program product, the device identification information associated with the recipient client device is identified from a network device associated with a trusted network provider using a header enrichment process.

Alternatively or additionally, in some embodiments of the computer program product, the custody transfer request data object further comprises device location data associated with the recipient client device, and the computer program instructions are further configured for identifying stored proximity data associated with the recipient client device; and comparing the device location data and the stored proximity data to determine whether the device location data is within a geographic region defined by the stored proximity data.

Alternatively or additionally, in some embodiments of the computer program product, the custody transfer request data object further comprises device user biometric data, and the computer program instructions are further configured for identifying confirmed biometric data associated with the recipient client device; and comparing the device user biometric data and the confirmed biometric data to determine whether the device user biometric data matches the confirmed biometric data.

Alternatively or additionally, in some embodiments of the computer program product, the transfer request information comprises a transfer item data object and transferor data object identification information associated with a transferor data object, and the computer program instructions further configured for querying the transfer record blockchain, based on the transfer data object, to identify a recorded possessor data object associated with the transfer item data object; receiving result data including the recorded possessor data object associated with the transfer item data object; and determining the recorded possessor data object matches the transferor data object.

Alternatively or additionally, in some embodiments of the computer program product, the custody transfer request data object further comprises device location data associated with the recipient client device, and the computer program instructions are further configured for identifying stored proximity data associated with the recipient client device; comparing the device location data and the stored proximity data to determine the device location data is not within a geographic region defined by the stored proximity data; and transmitting a transfer denial error to the recipient client device in response to the determination.

Alternatively or additionally, in some embodiments of the computer program product, the custody transfer request data object further comprises device user biometric data, and the computer program instructions further configured for identifying confirmed biometric data associated with the recipient client device; comparing the device user biometric data and the confirmed biometric data determine the device user biometric data does not match the confirmed biometric data; and transmitting a transfer denial error to the recipient client device in response to the determination.

Alternatively or additionally, in some embodiments of the computer program product, the transfer request information comprises a transfer item data object and transferor data object identification information associated with a transferor data object, and the computer program instructions further configured for querying the transfer record blockchain, based on the transfer data object, to identify a recorded possessor data object associated with the transfer item data object; receiving result data including the recorded possessor data object associated with the transfer item data object; determining the recorded possessor data object does not match the transferor data object; and transmitting a transfer denial error to the recipient client device in response to the determination.

Alternatively or additionally, in some embodiments of the computer program product, the transfer request information comprises a transferor user authentication information associated with a transferor data object, and the computer program instructions are further configured for authenticating the transferor user authentication information based on stored authentication information associated with the transferor data object.

Alternatively or additionally, in some embodiments of the computer program product, the associated transfer information set comprises (1) the device identification information, (2) transferor data object identification information associated with a transferor data object, (3) transfer item information associated with a transfer item data object, (4) a transfer timestamp, (5) image data associated with the transfer request information, or (6) a combination thereof.

In yet another example embodiment, another apparatus for frictionless custody chain management is provided. The apparatus comprises at least one processor and at least one memory, the at least one memory having computer-coded instructions thereon. The computer-coded instructions are configured to, in execution with the at least one processor, configure the apparatus to receive user transfer request information in response to user engagement; identify a transfer request destination URL associated with the user transfer request information; access the transfer request destination URL to cause transmission of device identification information to an authentication system via a header enrichment process and provide, to a custody management system, a custody transfer request data object associated with the user transfer request information, the custody transfer request data object comprising at least transfer item identification information; and receive a custody transfer response data object from the custody management system.

Alternatively or additionally, in some embodiments of the apparatus, to receive the user transfer request information, the apparatus is configured to capture a parseable image using at least one image capture device; parse the parseable image to identify encoded visual indicia; and decode the encoded visual indicia to receive the transfer request information. In some such embodiments of the apparatus, the encoded visual indicia comprises a QR code.

Alternatively or additionally, in some embodiments of the apparatus, to identify the transfer request destination URL, the apparatus is configured to parse the user transfer request information to identify the transfer request destination URL. Alternatively or additionally, in some embodiments of the apparatus, to identify the transfer request destination URL, the apparatus is configured to identify a pre-determined transfer request destination URL.

Alternatively or additionally, in some embodiments of the apparatus, the apparatus is further configured to receive device location data, wherein the custody transfer request data object further comprises the device location data for use in a device user authentication process.

Alternatively or additionally, in some embodiments of the apparatus, the apparatus is further configured to receive device user biometric data, wherein the custody transfer request data object further comprises the user biometric data for use in a device user authentication process.

In yet other example embodiments, another computer-implemented method for frictionless custody chain management is provided. The computer-implemented method comprises receiving user transfer request information in response to user engagement; identifying a transfer request destination URL associated with the user transfer request information; accessing the transfer request destination URL for causing transmission of device identification information to an authentication system via a header enrichment process and providing, to a custody management system, a custody transfer request data object associated with the user transfer request information, the custody transfer request data object comprising at least transfer item identification information; and receiving a custody transfer response data object from the custody management system.

Alternatively or additionally, in some embodiments of the computer-implemented method, receiving the user transfer request information comprises capturing a parseable image using at least one image capture device; parsing the parseable image to identify encoded visual indicia; and decoding the encoded visual indicia to receive the transfer request information. Additionally or alternatively, in some embodiments of the computer-implemented method the encoded visual indicia comprises a QR code.

Alternatively or additionally, in some embodiments of the computer-implemented method, identifying the transfer request destination URL comprises parsing the user transfer request information to identify the transfer request destination URL. Alternatively or additionally, in some embodiments of the computer-implemented method, identifying the transfer request destination URL comprises identifying a pre-determined transfer request destination URL.

Alternatively or additionally, in some embodiments of the computer-implemented method, the computer-implemented method further comprises receiving device location data, wherein the custody transfer request data object further comprises the device location data for use in a device user authentication process.

Alternatively or additionally, in some embodiments of the computer-implemented method, the method further comprises receiving device user biometric data, wherein the custody transfer request data object further comprises the user biometric data for use in a device user authentication process.

In yet other example embodiments, another computer program product for frictionless custody chain management is provided. The computer program product comprises a non-transitory computer readable storage medium having computer program instructions stored thereon. The computer program instructions, when executed by a processor, are configured for receiving user transfer request information in response to user engagement; identifying a transfer request destination URL associated with the user transfer request information; accessing the transfer request destination URL for causing transmission of device identification information to an authentication system via a header enrichment process, and providing, to a custody management system, a custody transfer request data object associated with the user transfer request information, the custody transfer request data object comprising at least transfer item identification information; and receiving a custody transfer response data object from the custody management system.

Alternatively or additionally, in some embodiments of the computer program product, receiving the user transfer request information comprises capturing a parseable image using at least one image capture device; parsing the parseable image to identify encoded visual indicia; and decoding the encoded visual indicia to receive the transfer request information. Alternatively or additionally, in some embodiments of the computer program product, the encoded visual indicia comprises a QR code.

Alternatively or additionally, in some embodiments of the computer program product, identifying the transfer request destination URL comprises parsing the user transfer request information to identify the transfer request destination URL. Alternatively or additionally, in some embodiments of the computer program product, identifying the transfer request destination URL comprises identifying a pre-determined transfer request destination URL.

Alternatively or additionally, in some embodiments of the computer program product, the computer program instructions are further configured for receiving device location data, wherein the custody transfer request data object further comprises the device location data for use in a device user authentication process.

Alternatively or additionally, in some embodiments of the computer program product, the computer program instructions are further configured for receiving device user biometric data, wherein the custody transfer request data object further comprises the user biometric data for use in a device user authentication process.

In yet another example embodiment, another apparatus for frictionless custody chain management is provided. The apparatus comprises means for receiving, from a recipient client device, a custody transfer request data object comprising transfer request information. The apparatus further comprises means for identifying device identification information associated with the recipient client device. The apparatus further comprises means for associating at least the device identification information with a transfer item data object to identify an associated transfer information set; and the apparatus further comprises means for storing, to a transfer record storage, a transfer record comprising the associated transfer information set.

In yet another example embodiment, another apparatus for frictionless custody chain management is provided. The apparatus comprises means for receiving user transfer request information in response to user engagement. The apparatus further comprises means for identifying a transfer request destination URL associated with the user transfer request information. The apparatus further comprises means for accessing the transfer request destination URL, including means for causing transmission of device identification information to an authentication system via a header enrichment process, and means for providing, to a custody management system, a custody transfer request data object associated with the user transfer request information, the custody transfer request data object comprising at least transfer item identification information. The apparatus further comprises means for receiving a custody transfer response data object from the custody management system.

It should be appreciated that, in some embodiments, an example apparatus may be provided for any of the above-described methods and/or methods described herein. For example, example apparatuses may include at least one processor and at least one memory, the memory including computer-coded instructions for performing any of the methods described herein. Similarly, an example computer program product may be provided for any of the above-described methods and/or methods described herein. For example, example computer program products may include at least one non-transitory computer-readable storage medium having computer program instructions thereon, the computer program instructions, in execution with a processor, configured for performing any of the methods described herein.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates a block diagram of a system that may be specially configured within which embodiments of the present disclosure may operate;

FIG. 2B illustrates a block diagram of an example apparatus that may be specially configured in accordance with an example embodiment of the present disclosure;

FIG. 2B illustrates a block diagram of an example apparatus that may be specially configured in accordance with an example embodiment of the present disclosure;

FIG. 3 illustrates a data flow diagram depicting operational data flow of an example system in accordance with an example embodiment of the present disclosure;

FIGS. 4-8 illustrate flowcharts depicting various operations performed in an example process for frictionless custody chain management in accordance with the perspective of a first example embodiment of the present disclosure; and

FIGS. 9-11 illustrate flowcharts depicting various operations performed in an example process for frictionless custody chain management in accordance with the perspective of a second example embodiment of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

### Overview

Custody chains enable tracking and auditing of transfers of various objects associated with various transfers. Such objects include, without limitation, items transferred between various users in commerce, supply chain management, evidence handling, humans moving throughout checkpoints, or the like. Such custody chains remain complete by having users to acknowledge transfer of an object, for example by signing a transmission report, at certain times associated with a transfer of the object, such as upon receiving the object via transfer from the previous possessor of the object. By acknowledging an object has been, the new recipient affirms the object is now under their control. The custody chain may be formed from all previous transfer reports associated with a particular object, such that the object may be audited or otherwise traced via the custody chain.

Conventional computer-implemented methods may be configured to maintain such custody chains. Such computer-implemented methods may be implemented via one or more computer systems to track such transfers. However, in such conventional systems, a user may be required to register for identification purposes, which could further be time consuming for the user and/or system, resource intensive for the system, or otherwise undesirable. Furthermore, after a user registers for use of the system, the user must subsequently maintain and provide necessary information to authenticate their identity with the system, often by providing credentials. Such a process may be untrustworthy, for example where a malicious user falsely uses credentials of another user. Additionally, requiring such authentication may be further time consuming, resource intensive, or otherwise undesirable.

Embodiments of the present disclosure provide frictionless custody chain management, for example by verifying a user using user identification information verifiable by at least one trusted third-party entity in control of a third-party system. A user may operate a client device to access a custody management system configured for providing frictionless custody chain management. In some embodiments, for example, a recipient user that receives a transfer item may, using an associated client device, transmit information to a custody management system for registering or otherwise recording the transfer. At least a portion of the transmitted information may include device identification information verifiable by a trusted third-party entity, such that verification by the trusted third-party entity and confirmation of such verification by the custody management system serves as authentication of the user's identity without the user being required to submit additional registration and/or authentication to the custody management system. For example, in some embodiments, the device identification information may be identified and/or verified using a header enrichment process, DAA process, login process with the third-party system, or other authentication process. The information may further include additional information for creating a transfer record, such as a transferor data object identifier, transfer item data object identifier, or the like. The custody management system may thus generate and/or store a new transfer record, based on the received information, representing a recent transfer between two users without requiring subsequent authentication by a recipient.

Various device identification information may be obtained and verified directly via a variety of third-party entities. For example, in some embodiments, the device identification information may be a mobile phone number associated with a client device that transmitted a custody transfer request data object, which may be automatically obtained and/or verified by a carrier associated with the client device. In other embodiments, other device identifiers, IP addresses, or the like may be received and/or obtained and verified by a corresponding entity, such as a network host entity, Internet service provider entity, or the like. Some or all of the device identification information may be automatically identified, and not require any submission by the

In some embodiments, the client device may be configured to provide services for recording such transfers via a service application executed on the client device, for example a web application or a native application (e.g., an “app”). The application may provide specific functionality for transmitting new custody transfer request data object(s) associated with new transfers of transfer items. In some particular embodiments, the application may be configured to enable image capture and/or processing to further enhance user experience. For example, in some embodiments, the application may be specially configured to capture a parseable image, and process the parseable image to identify one or more sets of information used in generating and/or transmitting a corresponding custody transfer request data object. For example, in a particular context, the service application may be specially configured to capture and parse a QR code to receive user transfer request information for use in generating and/or transmitting a corresponding custody transfer request data object. The QR code, for example, may be placed on, affixed to, or otherwise associated with a transfer item received by the user.

Embodiments of the present disclosure enhance overall system security using authentication of user identification information verifiable via a third-party entity. In this regard, such embodiments are less vulnerable to account hacking, social engineering attacks, and other credentials-based security flaws. In some embodiments, systems leveraging out-of-band network communications for identification and/or transmission of device identification may further improve overall system security against cyber-attacks such as man-in-the-middle attacks. Further, such embodiments improve overall processing functionality and save computing resources by reducing the computing resources used by the custody management system to store such authentication related information, and reducing the processing resources used by the custody management system to process such authentication related information. Additionally, such embodiments improve overall user experience by reducing the number of actions performed by a user, and in some embodiments provide a fully automated authentication process without any authentication-specific action performed by the user.

### Definitions

As used herein, the terms “data,” “content,” “information,” and similar terms may be used interchangeably to refer to data capable of being transmitted, received, and/or stored, for example in one or more “data object(s),” in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network” or “communications network.” Similarly, where a computing device is described herein to send data to another computing device, it will be appreciated that the data may be transmitted directly to another computing device or may be transmitted indirectly via one or more intermediary computing devices, such as, for example, one or more servers, relays, routers, network access points, base stations, hosts, and/or the like.

The term “client device” refers to computer hardware and/or software that is configured to access a service made available by a server. The server is often (but not always) on another computer system, in which case the client device accesses the service by way of a network. Client devices may include, without limitation, smart phones, tablet computers, laptop computers, wearables, personal computers, enterprise computers, and the like. The client devices described herein communicate with one or more systems or servers, for example an authentication system and/or a custody management system, via one or more communication network(s). The term “recipient client device” refers to a particular client device transmitting a custody transfer request data object to a custody management system.

The term “custody transfer request data object” refers to electronically transmitted data transmitted from a client device to a custody management system that indicates the user associated with the client device desires to record and/or approve transfer of an object, associated with a transfer item data object, from a transferor entity to the user associated with the client device. In some embodiments, a custody transfer request data object is transmitted to record a transfer in a frictionless manner (e.g., without requiring user action to authenticate their identity). Additionally or alternatively, in some embodiments, a custody transfer request data object is transmitted for approval by the custody management system.

The term “transfer request information” refers to data or information utilized by a custody management system to facilitate processing and/or completion of a custody transfer request data object. In some embodiments, transfer request information includes (1) device identification information associated with a client device transmitting the request, (2) transferor data object identification information associated with a transferor data object, (3) transfer item information associated with a transfer item data object, (4) a transfer timestamp, (5) image data, or (6) any combination thereof.

The term “device identification information” refers to electronically managed data or information that uniquely identifies a particular client device. In some such embodiments, due to the nature of the client device being kept in close control by an associated user, authentication of device identification information confirms identity of a user associated with the device identification information. Non-limiting examples of device identification information include an international mobile subscriber identity (IMSI) or telephone number, international mobile equipment identifier, integrated circuit card identifier (ICCID), media access control (MAC) address, and internet protocol (IP) address. In some embodiments, a trusted third-party device and/or system is configured to identify device identification information associated with a client device using a highly-secure process.

The term “associated transfer information set” refers to a portion, or all, of transfer information of a custody transfer request data object received by a custody management system and that is linked, or otherwise corresponds to, particular device identification information. For example, in some embodiments, a custody management system may associate at least a portion of transfer request information with device identification information injected into a custody management system using a header enrichment process. Alternatively, in some embodiments, a third-party system (such as a network device) may transmit device identification information associated with a session or other identifier, such as a transfer identifier, and the custody transfer request data object may be associated with the session or other identifier, such that the custody management system can generate the associated transfer information set by pairing the session or other identifier for each information set.

The term “transfer record” refers to electronically managed data representing a custody transfer of a transfer item data object from a transferor data object to a recipient data object. In some embodiments, the transfer record may memorialize and/or summarize a real-world transfer of an object from a transferor entity to a recipient entity (e.g., a first person to a second person). In some embodiments, a transfer record includes at least transfer item data object identification information and device identification information and/or transferee user data object identification information

The term “transfer record blockchain” refers to a fully-distributed or semi-distributed data storage configured to store one or more transfer records in a secure manner. In some embodiments, a transfer record blockchain is maintained by a custody management system, such that the custody management system is configured as permissioned to add to and/or read from the transfer record blockchain. In some embodiments, a transfer record blockchain is immutable, such that under designed circumstances, transfer records stored to the transfer record blockchain cannot be altered.

The term “trusted network provider” refers to an entity, such as a corporation, individual, group, brand operator, or the like, in control of a communications network over which a client device communicates with one or more devices, systems, or other computing hardware. Non-limiting examples of a trusted network provide include a carrier associated with providing mobile services to a client device embodied by a mobile device.

The term “network device” refers to hardware, circuitry, components, systems, or sub-systems of a communications network configured for receiving and/or relaying information and/or data objects, for example request data objects and response data objects, between various systems, devices, or the like. In some embodiments, additionally or alternatively, a network device is configured to perform one or more operations and/or processes for identifying an entity and/or device associated with the information or data object being transmitted. In some embodiments, as a non-limiting example, a network device is configured to perform a header enrichment process, another DAA authentication process, or any other network-based authentication process.

The term “header enrichment process” refers to a process for authenticating a client device or a user of the client device (for example, a mobile device) via a Direct Autonomous Authentication process, involving a packet header enrichment in which packet headers comprise device identification information, for example, injected therein by a trusted party such as a carrier, network provider or through a login process. For example, in some embodiments, a network injects a phone number associated with a mobile device within packet headers. In this manner, the authentication system may obtain device identification information without user input. application Ser. No. 15/424,595, entitled “Method and Apparatus for Facilitating Frictionless Two-Factor Authentication,” filed on Feb. 3, 2017, which is hereby incorporated by reference in its entirety, describes a number of exemplary processes for performing a Direct Autonomous Authentication process.

The term “device location data” refers to electronically managed information or data for use in identifying a particular geographic location at which a client device is located. In some embodiments, device location data is collected by one or more devices, components, or sub-systems of a client device. In some embodiments, device location data is collected and/or determined by one or more systems associated with the client device. Non-limiting examples of device location data include GPS information, longitude and latitude coordinates, address information, triangulation information or results, an ID address, or the like.

The term “stored proximity data” refers to electronically managed information or data that represents a geographic area associated with a particular client device, where the client device is authorized to act within the geographic zone. In some embodiments, stored proximity data is stored by a custody management system associated with device identification information associated with the corresponding client device,

The term “device user biometric data” refers to data or information embodying a biometric characteristic of a user received via interaction and/or engagement with a client device. Non-limiting examples of device user biometric data include fingerprint scan data, iris scan data, face scan data, walking gait scan data, handprint scan data, passcode data, pass pattern data, or other data associated with a physical or mental property of a user.

The term “confirmed biometric data” refers to data or information stored by an authentication system or custody management system associated with a particular client device or device identification information for use in comparing to received device user biometric data. For example, in some embodiments, an authentication system receives device user biometric data from a client device associated with received device identification information, and retrieves stored confirmed biometric data for comparison to identify the identity of the user associated with the client device.

The term “transferor data object” refers to electronically managed data or information, associated with a particular transferor user, that represents a particular entity, client device, or user associated with transferring a transfer item data object to a recipient. In some embodiments, a transferor data object is associated with device identification information for a client device that previous received a transfer item data object via a custody transfer.

The term “transfer item data object” refers to electronically managed data or information embodying or representing an object, good, or the like, for transfer between entities. In some embodiments, a transfer item data object embodies an electronic representation of a real-world item for transfer between users associated with various client devices. The term “transfer item identification information” refers to an electronically managed string, number, alphanumeric code, or other identifier that uniquely identifies a particular transfer item data object maintained by the custody management system.

The term “recorded possessor data object” refers to a particular transferor data object indicated as the last recipient of a transfer item data object. In some embodiments, for example, a recorded possessor data object is identified as a recipient data object in a most-recent transfer record associated with the transfer item data object. In some embodiments, a custody management system identifies a recorded possessor data object by querying a transfer record blockchain for a most-recent transfer record associated with a transfer item data object, where the recorded possessor data object is the recipient data object identified by the transfer record.

The term “transfer denial error” refers to signals, information, and/or data generated by a custody management system and transferred to a recipient client device indicating that a custody transfer request data object was not completed due to one or more authentication failures, and/or data processing check failures. In some embodiments, a transfer denial error is transmitted from a custody management system to a recipient client device in a custody transfer response data object.

The term “stored authentication information” refers to data or information stored by a custody management system associated with a particular client device, client device identification information, or other client device information, for confirming the identity of a client device, transferor data object, or recipient data object. In some embodiments, for example, stored authentication information is associated with a transferor data object corresponding to a particular custody transfer request data object, such that device identification information identified associated with the received custody transfer request data object can be compared to the stored authentication information to determine if the stored authentication information matches the identified device identification information to verify the transferor data object.

The term “user transfer request information” refers to electronically managed data or information captured, collected, or otherwise received by a client device for use in generating and/or transmitting a custody transfer request data object to a custody management system, and/or for use by the custody management system to process the custody transfer request data object. In some embodiments, user transfer request information includes (1) transferor data object identification information associated with a transferor data object, (2) transfer item information associated with a transfer item data object, (3) a transfer timestamp, (4) image data, (5) URL data, (6) data processing instructions, or (7) any combination thereof. In some embodiments, a client device captures and/or identifies user transfer request information, uses a first portion of transfer request information (e.g., a transfer request destination URL) to transmit a corresponding custody transfer request data object including a second portion of user transfer request information. In some embodiments, a client device is configured to capture, collect, or otherwise receive a parseable image including user transfer request information.

The term “user engagement” refers to any interaction received and/or detected by a client device, and interpretable by the client device for performing one or more associated processes. In some embodiments, a client device is configured using a combination of hardware and specially configured software (e.g., a specially configured service application). Non-limiting examples of user engagement include button presses, taps, eye movements, voice commands, gestures, keystrokes, mouse clicks, peripheral interactions, and/or the like. In some embodiments, in an example context, a client device is configured to activate one or more hardware components in response to user engagement. In an example context, a client device is configured to receive user transfer request information input by a user of the client device in response to user engagement, for example by capturing a parseable image using one or more image capture device(s) in response to user engagement.

The term “transfer request destination URL” refers to a specially configured uniform resource locator identifying a target device, component, and/or system to which the client device should transmit a custody transfer request data object for processing by a custody management system. In some embodiments, the transfer request destination URL is associated with a network device configured to receive a custody transfer request data object, perform a header enrichment process, and forward the custody transfer request data object and/or corresponding device identification information to one or more of an authentication system and a custody management system. In some embodiments, the transfer request destination URL terminates at a network device included in a trusted provider network. In other embodiments, the transfer request destination URL terminates at an authentication system or a custody management system.

The term “authentication system” refers to computing hardware, circuitry, server, device, system, or sub-system configured to verify the identity of a user associated with a client device, or the identity of the client device. In some embodiments, the authentication system is a sub-system of a custody management system. In other embodiments, the authentication system is another system associated with the custody management system, and controlled by a shared entity. In yet other embodiments, the authentication system is a third-party system. In some embodiments, the authentication system is configured to receive device identification information indirectly from a client device using a packet header enrichment process, DAA process, or other network-based authentication process. In some embodiments, the authentication system automatically verifies received device identification information, for example when device identification information is received via a header enrichment process. In some embodiments, received device identification information is compared to stored information to determine whether the information matches.

In some embodiments, the authentication system controls process flow of a custody management system. For example, in some embodiments, the authentication system is configured to transmit a continuation signal, to cause the custody management system to continue processing a request, upon verifying the identity of a user or client device. Similarly, in some embodiments, the authentication system is configured to transmit a termination signal, to cause the custody management system to generate an error or otherwise terminate processing of a request, upon failing to verify the identity of a user or client device.

The term “custody management system” refers to computing hardware, circuitry, one or more devices, servers, systems, and/or sub-systems, configured for receiving a custody transfer request data object and processing the custody transfer request data object. In some embodiments, a custody management system maintains a transfer record blockchain for enabling a chain of custody analysis for one or more transfer item data objects associated with various transfer records stored in the transfer record blockchain. In some embodiments, the custody management system, alone or in conjunction with an authentication system, is configured to automatically identify a recipient data object based on device identification information automatically received from the client device, for example using a packet header enrichment process, to facilitate frictionless custody chain management.

The term “custody transfer response data object” refers to electronically generated data, information, and/or signals transmitted from a custody management system to a client device in response to a received custody transfer request data object. In some embodiments, a custody transfer response data object includes a transfer denial error that indicates the custody transfer request data object could not be completely processed. In some embodiments, a custody transfer response data object includes information indicating that a transfer record associated with the custody transfer response data object was successfully created and stored. In some such embodiments, the custody transfer response data object may include information associated with or identifying the generated transfer record.

The term “image capture device” refers to one or more hardware components, devices, circuitry, and/or sub-systems, and/or associated software and/or firmware, of a client device for capturing image data. Non-limiting examples of an image capture device include a camera, imagery sensor(s), environment reconstruction system, and the like. In some embodiments, an image capture device is configured, through hardware and/or software, to capture a parseable image for processing by the client device.

The term “parseable image” refers to image data captured, collected, and/or otherwise received by a client device, where the image data is parseable to identify encoded visual indicia within the image data. In some embodiments, a client device is configured to parse the parseable image using one or more parsing methodologies to identify, or otherwise extract, the encoded visual indicia for analysis. In some embodiments, a parseable image is captured by an image capture device associated with a client device. For example, in some embodiments, a parseable image is a camera image, captured by a camera of a mobile device, for processing by the mobile device.

The term “encoded visual indicia” refers to data representing user transfer request information in a visually detectable and/or decodable presentation. In some contexts, encoded visual indicia is printed, etched into, or otherwise provided physically or digitally associated with a transfer item for capturing via a client device to facilitate generation of a transfer record associated with a transfer of a transfer item. In some embodiments, encoded visual indicia is decodable, for example by a client device, using one or more decoding methodologies, to receive user transfer request information. In some embodiments, encoded visual indicia is presented via an encoded pattern detectable and/or decodable by a specially configured client device. Non-limiting examples of encoded visual indicia include one or more QR code(s), barcode(s), character-encoded pattern(s) (for example, a binary encoded number, an encoded text string, or the like), encoded images, or encoded pattern(s) (for example, color-coded patterns), or a combination thereof.

### System Architecture and Example Apparatus

The methods, apparatuses, systems, and computer program products of the present disclosure may be embodied by any variety of devices. For example, a method, apparatus, system, and computer program product of an example embodiment may be embodied by a fixed computing device, such as a personal computer, computing server, computing workstation, or a combination thereof. Further, an example embodiment may be embodied by any of a variety of mobile terminals, mobile telephones, smartphones, laptop computers, tablet computers, or any combination of the aforementioned devices.

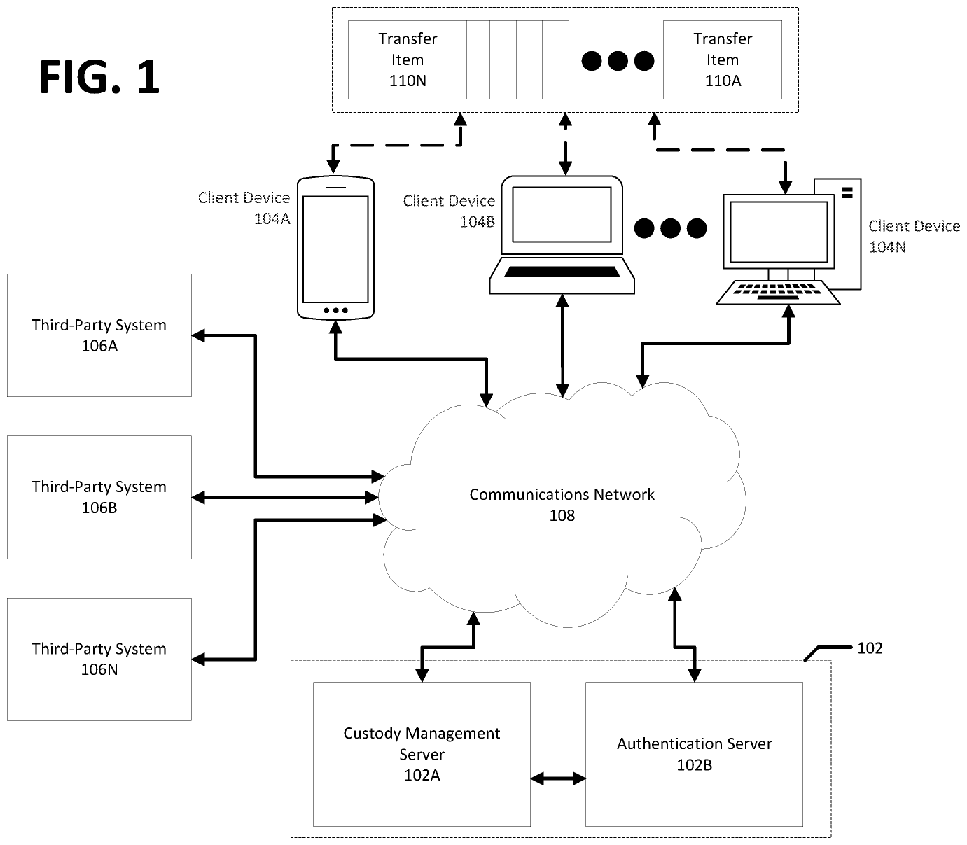

In this regard, FIG. 1 illustrates an example computing system in which embodiments of the present disclosure may operate. FIG. 1 illustrates an overview for a system configured for frictionless custody chain management. Specifically, in such a system, one or more client devices may communicate with a custody management system, the custody management system in communication with one or more third-party systems, for performing frictionless custody chain management.

The system illustrated includes a custody management system 102 in communication with one or more client devices 104A-104N (collectively “client devices 104”). The custody management system 102, in some embodiments is further in communication with one or more third-party systems 106A-106N (collectively “third-party systems 106”). The various systems may communicate over a communications network 108. In some embodiments, the various systems may communicate over a plurality of communications networks, including communications network 108, such as a carrier network and a Wi-Fi network.

Any number, or all, of the client devices 104 may be associated with or embodied by any number of known computing devices. For example, one or more of the client devices 104 may be embodied by a mobile phone, smart phone, tablet, laptop, personal computer, wearable device, set-top box, Internet-of-Things (IoT) device, or the like. Each of the client devices 104 may be associated with a user entity that rightfully owns, possesses, controls, or otherwise has permissible access to the corresponding client device. In some embodiments, each of the client devices 104 may be secured with one or more use security verification processes for gaining access to functionality provided by the client device (e.g., one or more passcodes, fingerprints, face, or other biometric scan, or the like, or a combination thereof). Accordingly, receiving device identification information associated with one of the client devices 104 serves as a proxy for confirming the user's identity associated with the client device, as the user has been successfully authenticated via the corresponding identity verification process(es).

Each of the client devices 104 may be configured to provide particular functionality associated with custody chain management. In this regard, each client device may be configured via customized hardware, software, or a combination of hardware and software, to provide functionality for generating and/or transmitting one or more custody transfer request data object(s) associated with received and/or transferred transfer items. For example, the client devices 104 may be configured to interact with the transfer items 110A-110N. In some such embodiments, for example, each of the client devices 104 may be configured to receive user transfer request information associated with the transfer of one or more of the transfer items 110 in response to user engagement via the client device. Each of the client devices 104 may use one or more components, such as sensors, cameras, peripherals, and/or the like, to receive the user transfer request information. For example, in some embodiments, a user may utilize a camera or other image capture device associated with a client device to capture a parseable image for analysis by the corresponding client device to receive corresponding user transfer request information. It should be appreciated that the transfer items 110 may embody any number of objects (e.g., purchased items, transferred items, gifts, or the like), materials, humans being escorted through checkpoints (e.g., prison checkpoints), or the like.

In some embodiments, a client device may execute a service application specially configured to provide such functionality. For example, the client device may access, download, and/or otherwise install the service application from one or more servers. For example, in some embodiments, the service application may be downloaded and installed to the client device as a native application for execution by the client device. Additionally or alternatively, the client device may execute a browser application or other web-access application to enable access of the service application, for example from the custody management system 102 or an associated server or system.

The custody management system 102 may be embodied by one or more computing systems, apparatuses, devices, or the like, configured for frictionless custody chain management. In this regard, the custody management system 102 includes one or more components, systems, apparatuses, devices, or the like, for receiving signals from and/or transmitting signals and/or corresponding data objects to various communicable devices, for example the client devices 104 and/or the third-party systems 106, and/or for performing one or more of the processes described herein. In some embodiments, the custody management system 102 includes a custody management server 102A. Additionally or alternatively, in some embodiments, the custody management system 102 includes an authentication server 102B. In other embodiments, the authentication server 102B may be external to the custody management system 102, for example where the authentication server 102B is a third-party controlled system communicable with the custody management system over a network, such as the network 108.

The custody management server 102A may be configured via hardware, software, or a combination of software and hardware to communicate with the one or more client devices 104 over a network, such as the network 108 or one or more sub-networks or associated networks therein. Additionally or alternatively, in some embodiments, the custody management server 102A may be configured for executing computer-coded instructions for one or more operations for receiving and/or processing request data objects received from various client devices, for example custody transfer request data objects. In this regard, the custody management server 102A may be configured for receiving a custody transfer request data object, identifying and/or otherwise parsing information from the custody transfer request data object, performing one or more authentication processes based on the identified information, and storing a new transfer record including at least a portion of the parsed and/or identified information. In performing one or more of the above actions, the custody management server may communicate with the client devices 104 and/or the third-party systems 106, for example using a network interface.

The custody management server 102A may include or be associated with one or more database(s) embodied in hardware, software, or a combination of software and hardware. In some embodiments, the database(s) may include at least one data storage device, such as one or more memory devices, hard disks, network attached storage (NAS) device(s), or a separate database server or servers. The database(s) may be configured for storing, retrieving, and/or otherwise maintaining data associated with custody chain management. For example, in some embodiments, the database(s) may include device identification information and/or associated user data objects, transfer item data object(s), transfer record(s), third-party system identification and/or communication information, or the like. In some embodiments, for example, the database(s) may include one or more transfer report storage(s), such as a transfer report database and/or transfer report blockchain managed by the custody management server 102A. In this regard, the custody management server 102A may be configured to generate a new transfer record. Additionally or alternatively, the custody management server 102A may be configured to store the new transfer record to the transfer report database and/or blockchain. In some embodiments, additionally or alternatively, the custody management server 102A is configured to retrieve information from the transfer report database and/or blockchain for various auditing, authentication, and/or other verification purposes.

The authentication server 102B may be configured for identifying, receiving, and/or retrieving information associated with a client device transmitting a request data object to the custody management system 102, including but not limited to device identification information, device location data, device user biometric data, transferor and/or recipient identification information, and/or the like. Additionally or alternatively, in some embodiments, the authentication server 102B is configured to perform one or more authentication and/or verification processes based on the identified, received, and/or retrieved information. In some embodiments, the authentication server 102B is configured to identify and/or authenticate device identification information associated with a client device using a header enrichment process, DAA process, or other third-party verifiable information process. Additionally or alternatively, in some embodiments, the authentication server 102B may maintain one or more of its own databases and/or communicate with one or more database(s). The database(s) may be configured to store, maintain, and/or retrieve information related to the one or more authentication processes performed by the authentication server 102B. For example, the authentication server 102B may include or communicate with one or more database(s) that store device identification information, information embodying or associated with user biometrics, location data associated with client device(s), and/or the like. In some embodiments, the authentication server 102B communicates with or otherwise accesses database(s) similarly communicable and/or maintained by the custody management server 102A. Alternatively, in some embodiments, one or more of the database(s) operated by the authentication server 102B is shared between the custody management server 102A and the authentication server 102B. In yet other embodiments, the custody management server 102A and the authentication server 102B share access to all database(s).

Any number, or all, of the third-party systems 106 may be associated with or embodied by a third-party server, device, or other hardware. In this regard, the third-party systems 106 may comprise hardware and/or software for retrieving and/or authenticating device identification information associated with a particular client device. Each of the third-party systems 106 may be associated with a different third-party entity. For example, one or more of the third-party systems 106 may be associated with a hardware manufacturer, a device provider, a carrier, a software as a service provide associated with a particular service, or the like. For example, in some embodiments, a third-party system may be associated with a carrier entity for one or more of the client devices 104. For example, the third-party system 106A may be a carrier device associated with the carrier network, for example embodying the communications network 108, accessible to the client device 104A. The carrier device embodied by one of the third-party systems 106 may be configured to perform a header enrichment process to identify device identification information, such as a phone number, associated with a client device as the client device transmits requests to the custody management system 102. Other systems of the third-party systems 106 may utilize other identification and/or authentication processes to identify and/or authenticate device identification information verifiable by the third-party system.

The authentication server 102B may communicate with one or more of the third-party systems 106 as part of one or more authentication processes. For example, the authentication server 102B may retrieve and/or otherwise receive device identification from one of the third-party systems 106. Additionally or alternatively, the authentication server 102B may communicate with one of the third-party systems 106 to authenticate information, for example device identification information, received by the authentication server 102B from one of the client devices 104.

Additionally or alternatively, some or all of the third-party systems 106 may provide additional functionality associated with processing custody transfer request data object(s) by a custody management system 102. For example, a custody management server 102A may communicate with one or more of the third-party systems 106 to provide initiate a payment associated with a custody transfer request data object associated with a transfer of a transfer item. Additionally or alternatively, the custody management server 102A may communicate with one or more of the third-party systems 106 to access data processing and/or storage functionality, information retrieval functionality associated with transfer request information, and/or the like.

It should be appreciated that, in some embodiments, the custody management system 102 comprises only a single system that functions to perform the operations of both the custody management server 102A and authentication system 102B. Further, in some embodiments, the custody management system 102 may be configured to perform one or more additional, enhanced, and/or alternative operations as described herein. Such operations may be performed by the custody management server 102A, authentication server 102B, a combination thereof, a single server embodying a combination of the servers, and/or other servers or computing hardware not depicted. For example, in some embodiments, one or more databases may be embodied by one or more external server devices comprising and/or associated with memory storage devices.

The system includes network 108 for facilitating communications between the client devices 104 and custody management system 102, and the communications between custody management system 102 and third-party systems 106. In some embodiments, the network 108 includes one or more sub-networks comprising a combination of shared and/or independent network devices. For example, network 108 may be embodied by, or include a sub-network embodied by, a carrier network comprising at least one carrier device controlled by a carrier entity, such as a mobile phone carrier entity associated with one or more of the client devices 104. One or more of the client devices 104 may communicate with the custody management system 102 via the carrier network, for example embodied by network 108 or a sub-network thereof, to enable one or more authentication processes, such as a DAA process, header enrichment process, and/or the like. In this regard, the carrier network may be an out-of-band network with respect to one or more other sub-networks, or other networks associated with the network 108 over which the client devices 104 can communicate, to prevent channel-based cyber-attacks and ensure verifiability of received information (such as device identification information). In some embodiments for example, the custody management system 102 may include a carrier device serving as an end-point for a header enrichment process via the carrier network, embodied by communications network 108. Additionally or alternatively in some embodiments, the network 108 may be embodied by any number of known network configurations, including, without limitation, one or more Wi-Fi networks, LAN networks, WLAN, networks, and the like, comprised of any number and/or combination of known network devices.

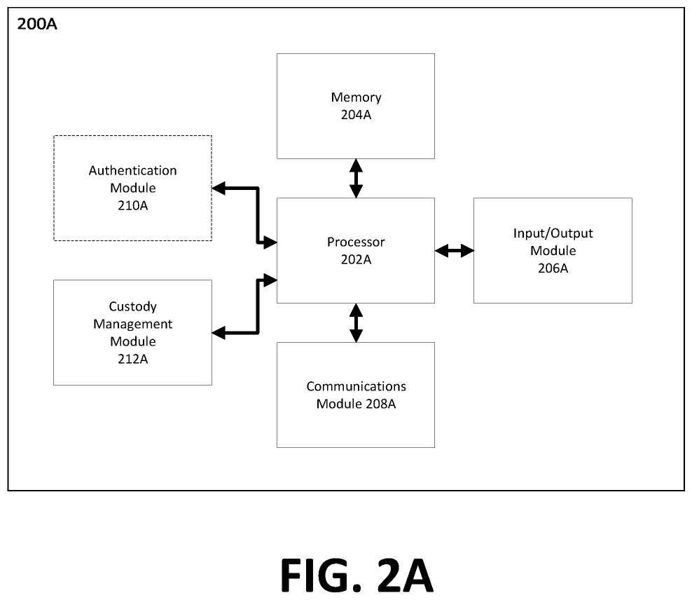

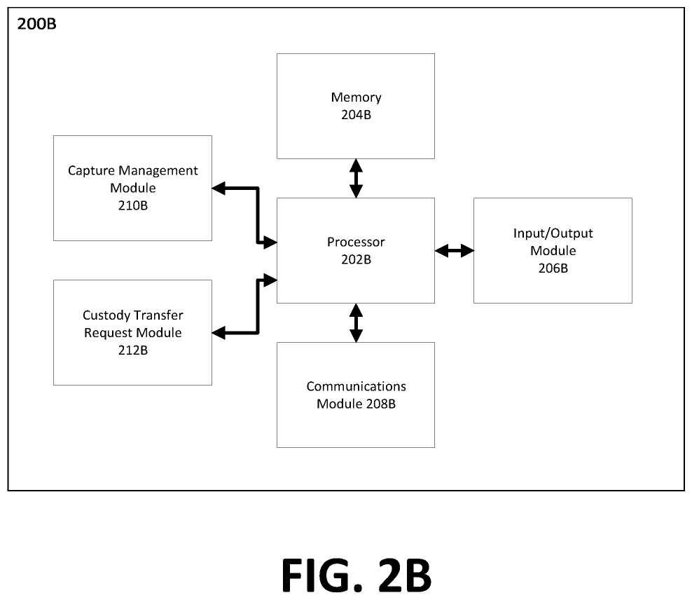

The custody management system 102, and/or one or more sub-devices thereof, may be embodied by one or more computing systems, devices, or apparatuses, for example the apparatus 200A depicted in FIG. 2A. As illustrated, the apparatus 200A may include several modules and/or components, such as processor 202A, memory 204A, input/output module 206A, communications module 208A, and custody management module 212A. In some embodiments, additionally or alternatively, the apparatus 200A includes authentication module 210A. The apparatus 200A may be configured, using such means as the modules 202A-212A, to perform the operations described herein. Although these components 202A-212A are described with respect to functional limitations, it should be understood that a particular implementation necessarily includes the use of particular hardware. It should also be understood that certain of these components 202A-212A may include similar or common hardware. For example, two modules or sets of modules may both leverage the same processor, network, interface, storage medium, and/or the like, to perform their associated functions, such that duplicate hardware is not required for each module. The terms “module” and “circuitry” as used herein with respect to the components of the apparatus 200A should therefore be understood to include particular hardware configured to perform the functions associated with the particular component, as described herein.

Indeed, the terms “module” and “circuitry” should be understood broadly to include hardware and, in some cases, software and/or firmware for configuring the hardware. For example, in some embodiments, the term “module” may include processing circuitry, storage medium(s), network interface(s), input/output device(s), and the like. In some embodiments, the processor 202A (and/or co-processor and any other processing module assisting or otherwise associated with the processor) may be in communication with the memory 204A via a bus for passing information among components of the apparatus 200A. The memory 204A may be non-transitory and, for example, include one or more volatile and/or non-volatile memories. In other words, for example, the memory 204A may be an electronic storage device (e.g., a computer readable storage medium). The memory 204A may be configured to store information, content, applications, instructions, or the like, for enabling the apparatus to carry out various functions in accordance with example embodiments of the present disclosure.

The processor 202A may be enabled in a number of different ways and may, for example, include one or more processing devices configured to perform independently. Additionally or alternatively, the processor may include one or more processes configured in tandem with a bus to enable independent execution of instructions, pipelining, and/or multi-threading. The use of the terms “processor,” “processing module,” and “processing circuitry” may be understood to include a single core processor, a multi-core processor, multiple processors internal to the apparatus, and/or one or more remote or “cloud” processors.

The processor 202A may be configured to execute instructions stored in the memory 204A, or otherwise accessible to the processor. Additionally or alternatively, the processor may be configured to execute hard-coded functionality. As such, whether configured by hardware methods, software methods, or a combination thereof, the processor may represent an entity (e.g., physically embodied in the circuitry) capable of operations according to an embodiment of the present disclosure while configured accordingly. Alternatively, as another example, when the processor is embodied as an executor of software instructions, the instructions may specifically configure the processor to perform the algorithms and/or operations described herein when the instructions are executed.

In some embodiments, the apparatus 200A may include input/output module 206A that may, in turn, be in communication with processor 202A to provide output to the user and, in some embodiments, to receive an indication of user engagement. The input/output module 206A may comprise a user interface, which may include a display controlled by or associated with a web interface, a mobile application, and/or another user interface, or the like. In some embodiments, the input/output module 206A may include a keyboard, a mouse, a touch screen, touch areas, soft keys, a microphone, a speaker, and/or other input/output mechanisms. The processor and/or user interface module comprising the processor may be configured to control one or more elements of a user interface through computer program instructions (e.g., software and/or firmware) stored on a memory accessible to the processor such as memory 204A and/or the like.

The communications module 208A may be any means, such as a device, component, and/or circuitry, embodied in either hardware or a combination of hardware and software, that is configured to receive and/or transmit data from and/or to another system, device, module, circuitry, or the like, communicable with the apparatus 200A. The communications module 208A may include, for example, one or more network interfaces for enabling communications with one or more wired or wireless communication networks. For example, the communications module 208A may include, for example, one or more network interface cards, antennas, buses, switches, routers, modems, and/or supporting hardware and/or software, and/or any other device suitable for enabling communications via one or more network(s). Additionally or alternatively, the communications module 208A may include a communications interface including circuitry for interacting with the antenna(s) to cause transmission of signals via the antenna(s) or to handle receipt of signals via the antenna(s).

The authentication module 210A includes hardware, software, or a combination thereof, for receiving signals, data objects, or the like, for processing received signals to authenticate the identity of a client device and/or user associated with a client device. For example, the authentication module 210A may include hardware, software, or a combination thereof for receiving and/or identifying device identification information, device location data, device user biometric data, transferor data object identification information, and/or the like from received signals and/or information received from a client device and/or third-party system, including but not limited to from received custody transfer request data object(s). Additionally or alternatively, the authentication module 210A may include hardware, software, or a combination thereof, for retrieving and/or identifying stored information utilized to authenticate the identity of a client device and/or user associated with a client device, for example stored proximity data, confirmed biometric data, transfer record(s), and/or the like. Additionally or alternatively, the authentication module 210A may include hardware, software, or a combination thereof, for processing the received and/or identified information from the client device and/or external system with the retrieved and/or identified stored information. In this regard, the authentication module 210A may analyze the data to determine whether to authenticate a particular client device and/or user associated with a particular client device, and to generate and/or transmit a corresponding signal, error message, or combination thereof. In some embodiments, authentication module 210A may include software, hardware, or a combination thereof to make a determination as to whether the received and retrieved data matches, and generate one or more signals based on the determination.

It should be appreciated that, in some embodiments, the authentication module 210A performs one or more of the aforementioned operations alone, or in combination with one or more other modules of the apparatus 200A. For example, in some embodiments, the authentication module 210A may leverage the processor 202A for processing functionality and the communications module 208A for data reception functionality. In yet some embodiments, the authentication module 210A may include a separate processor, specially configured field programmable gate array (FPGA), or specially configured application specific integrated circuit (ASIC). The authentication module 210A is configured, in some embodiments, to perform one or more additional and/or alternative functions, and/or partial operations or whole operations described with respect to one or more other modules as illustrated.

The custody management module 212A includes hardware, software, or a combination thereof, for receiving signals, data objects, or the like, for processing custody transfer data objects, and/or otherwise maintaining data associated with custody chain management. For example, the custody management module 212A may include hardware, software, or a combination thereof, configured to identify device information associated with a recipient client device. Additionally or alternatively, the custody management module 212A may include hardware, software, or a combination thereof, configured to identify and/or parse transfer request information from a received custody transfer request data object. Additionally or alternatively, the custody management module 212A may include hardware, software, or a combination thereof, to generate a transfer record based on a received custody transfer request data object, or identified and/or parsed transfer request information. Additionally or alternatively, the custody management module 212A may include hardware, software, or a combination thereof to generate and/or store a transfer record to a transfer record storage, such as a transfer record blockchain. Additionally or alternatively, the custody management module 212A may include hardware, software, or a combination thereof, configured to access and/or retrieve data, such as transfer records and/or associated metadata, from a transfer record blockchain and/or one or more other databases, repositories, or the like.

Additionally or alternatively, in some embodiments, the custody management module 212A is configured to perform and/or initiate one or more additional processes in response to successfully processing a custody transfer request data object and/or storing a transfer record. For example, in some embodiments, a custody management module 212A may be configured to generate and transmit a request to initiate a transfer of electronically managed currency between an account associated with a transferee user account and a transferor user account. In some such embodiments, the request may be transmitted to a third-party system to initiate the transfer via the third-party system. In other embodiments, the custody management module 212A may be configured to identify the user accounts and perform the transfer without use of a third-party system.

In some embodiments, the custody management module 212A is configured to enable registration of a new transfer item. For example, the custody management module 212A may include hardware, software, or a combination thereof, to receive transfer item information and/or a request to create a new transfer item data object associated with such transfer item information. The custody management module 212A may generate and store a new transfer item data object, for example to a transfer item repository and/or transfer record storage. In some embodiments, additionally or alternatively, the custody management module 212A may be configured to store information, for example a specially configured transfer record, to a transfer record blockchain indicating the new transfer item data object is associated with the that registered the client device that transmitted the information for registration. In this regard, the transfer record may indicate the user that submitted the request is the original recorded possessor of the transfer item data object.

It should be appreciated that, in some embodiments, the custody management module 212A performs one or more of the aforementioned operations alone, or in combination with one or more other modules of the apparatus 200A. For example, in some embodiments, the custody management module 212A may leverage the processor 202A for processing functionality and/or the communications module 208A for data reception functionality. In yet some embodiments, the custody management module 212A may include a separate processor, specially configured FPGA, or specially configured ASIC. The custody management module 212A is configured in some embodiments, to perform one or more additional and/or alternative functions, and/or partial operations or whole operations described with respect to one or more other modules as illustrated.

It should be appreciated that all or some of the information and/or data managed or processed by the apparatus 200A is received, generated, and/or maintained by one or more of the components of the apparatus 200. In some embodiments, one or more external systems, including but not limited to third-party systems, client devices, remote cloud computing systems, remote data storage systems, and/or the like, may be leveraged to provide some or all of the functionality described herein.

One or more of the client devices 104 may be embodied by one or more computing systems, apparatuses, devices, or the like, for example apparatus 200B depicted in FIG. 2B. As illustrated in FIG. 2B, the apparatus 200B may include a processor 202B, memory 204B, input/output module 206B, communications module 308B, capture management module 310B, and custody transfer request module 212B. In some embodiments, other elements of the apparatus 200B may provide or supplement the functionality of particular modules. For example, the processor 202B may provide processing functionality, the memory 204B may provide storage functionality, and the communications module 208B may provide network interface functionality, and the like. As it relates to the operations described in the present disclosure, the functioning of the processor 202B, the memory 204B, the input/output module 206B, and/or the communications module 208B may be similar to the similarly named components described above with respect to FIG. 2A. For the sake of brevity, additional description of the mechanics and functionality of these components is omitted. Nonetheless, these device components, whether operating alone or together, provide the apparatus 200B with the functionality necessary to facilitate the communication of data and information between the apparatus 200B and one or more devices and/or systems, such as a custody management system, over one or more network(s).

The capture management module 210B includes hardware, software, or a combination thereof for capturing user engagement and/or associated data, information, signals, and/or the like, for initiating transmission of an associated custody transfer request data object. In some embodiments, the capture management module 210B comprises one or more image capture device(s), camera(s), sensor(s), and/or the like for capturing the environment of the apparatus 200B, for example in response to received user engagement. Additionally or alternatively, the capture management module 210B may include hardware, software, or a combination thereof, configured to process user engagement, activate one or more hardware components, and process data captured via the hardware components (or captured and pre-processed before further processing by the capture management module 210B).

For example, in some embodiments, the capture management module 210B includes hardware, software, or a combination thereof, configured to capture a parseable image using at least one image capture device. Additionally or alternatively, in some embodiments, the capture management module 210B includes hardware, software, or a combination thereof, configured to parse a captured parseable image to identify user transfer request information. Additionally or alternatively, in some embodiments, the capture management module 210B includes hardware, software, or a combination thereof, to decrypt encrypted user transfer information. Additionally or alternatively, in some embodiments, the capture management module 210B includes hardware, software, or a combination thereof, to parse and/or identify information within identified and/or parsed user transfer request information, for example one or more URLs, transferor data object identification information, transfer item information, and/or the like.

It should be appreciated that, in some embodiments, the capture management module 210B performs one or more of the aforementioned operations alone, or in combination with one or more other modules of the apparatus 200B. For example, in some embodiments, the capture management module 210B leverages the processor 202B for processing functionality and/or the communications module 208B for data reception functionality. In yet some embodiments, the capture management module 210B may include a separate processor, specially configured FPGA, or specially configured ASIC. The capture management module 210B is configured, in some embodiments, to perform one or more additional and/or alternative functions, and/or partial operations or whole operations described with respect to one or more other modules as illustrated.

The custody transfer request module 212B includes hardware, software, or a combination thereof, configured for processing information to generate and/or transmit a custody transfer request data object, and process response information associated with the request. In some embodiments, the custody transfer request module 212B includes, or is associated with, one or more hardware components having a specialized function to receive user and/or device data. Non-limiting examples include location services components, biometric scanning components, and/or the like, to provide some or all of the functionality described herein.

For example, in some embodiments, the custody transfer request module 212B includes hardware, software, or a combination thereof, configured to identify information from user transfer request information, for example one or more transfer request destination URLs. Additionally or alternatively, in some embodiments, the custody transfer request module 212B includes hardware, software, or a combination thereof, configured to access a transfer request destination URL. Additionally or alternatively, in some embodiments, the custody transfer request module 212B includes hardware, software, or a combination thereof, configured to cause transmission of device identification information to an authentication system, which may be performed via one or more processes, such as a header enrichment process. Additionally or alternatively, in some embodiments, the custody transfer request module 212B includes hardware, software, or a combination thereof, configured to provide a custody transfer request data object associated with identified and/or received user transfer request information, for example via transmission to a custody management system. Additionally or alternatively, in some embodiments, the custody transfer request module 212B includes hardware, software, or a combination thereof, configured to receive response information, data objects, and/or the like, such as a custody transfer response data object, and to output such information and/or process the received response information, data objects, and/or the like for one or more subsequent actions. Additionally or alternatively, in some embodiments, the custody transfer request module 212B includes hardware, software, or a combination thereof, configured to receive and/or identify device and/or user data, such as biometric data, location data, and/or the like.

Additionally or alternatively, in some embodiments, the custody transfer request module 212B is configured to enable input of information and/or communication with a custody management system for registering a new transfer item data object. For example, in some embodiments, the custody transfer request module 212B includes hardware, software, or a combination thereof, for receiving transfer item information from a user for use in generating a corresponding new transfer item data object. The custody transfer request module 212B may, alone or with one or more other modules, generate and/or render an interface configured for receiving such information. Additionally or alternatively, the custody transfer request module 212B may include hardware, software, or a combination thereof to generate a request including the received information and/or otherwise transmit the information to a custody management system, or another associated system, for registering a new transfer item data object associated with such information.

It should be appreciated that, in some embodiments, the custody transfer request module 212B performs one or more of the aforementioned operations alone, or in combination with one or more other modules of the apparatus 200B. For example, in some embodiments, the custody transfer request module 212B leverages the processor 202B for processing functionality and/or the communications module 208B for data reception functionality. In yet some embodiments, the custody transfer request module 212B may include a separate processor, specially configured FPGA, or specially configured ASIC. The custody transfer request module 212B is configured, in some embodiments, to perform one or more additional and/or alternative functions, and/or partial operations or whole operations described with respect to one or more other modules as illustrated.

As described above and as will be appreciated based on this disclosure, embodiments of the present disclosure may be configured as methods, mobile devices, frontend graphical user interfaces, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Similarly, embodiments may take the form of a computer program code stored on at least one non-transitory computer-readable storage medium. Any suitable computer-readable storage medium may be utilized including non-transitory hard disks, CD-ROMs, flash memory, optical storage devices, or magnetic storage devices.

As will be appreciated, any such computer program instructions and/or other type of code may be loaded onto a computer, processor or other programmable apparatus's circuitry to produce a machine, such that the computer, processor, or other programmable circuitry that execute the code on the machine creates the means for implementing various functions, including those described herein.

The computing systems described herein can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any inventions or of what may be claimed, but rather as description of features specific to particular embodiments of particular inventions. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. Any operational step shown in broken lines in one or more flow diagrams illustrated herein are optional for purposes of the depicted embodiment.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results, unless described otherwise. In certain implementations, multitasking and parallel processing may be advantageous.

### Example System Data Flow

Having thus described an example system and example apparatuses, an example data flow will now be described. It will be appreciated that the described data flows, operations and/or, processes therein, and the like, are non-limiting examples, and embodiments may perform various data flows, processes, and/or operations in a myriad of ways using various system configurations.

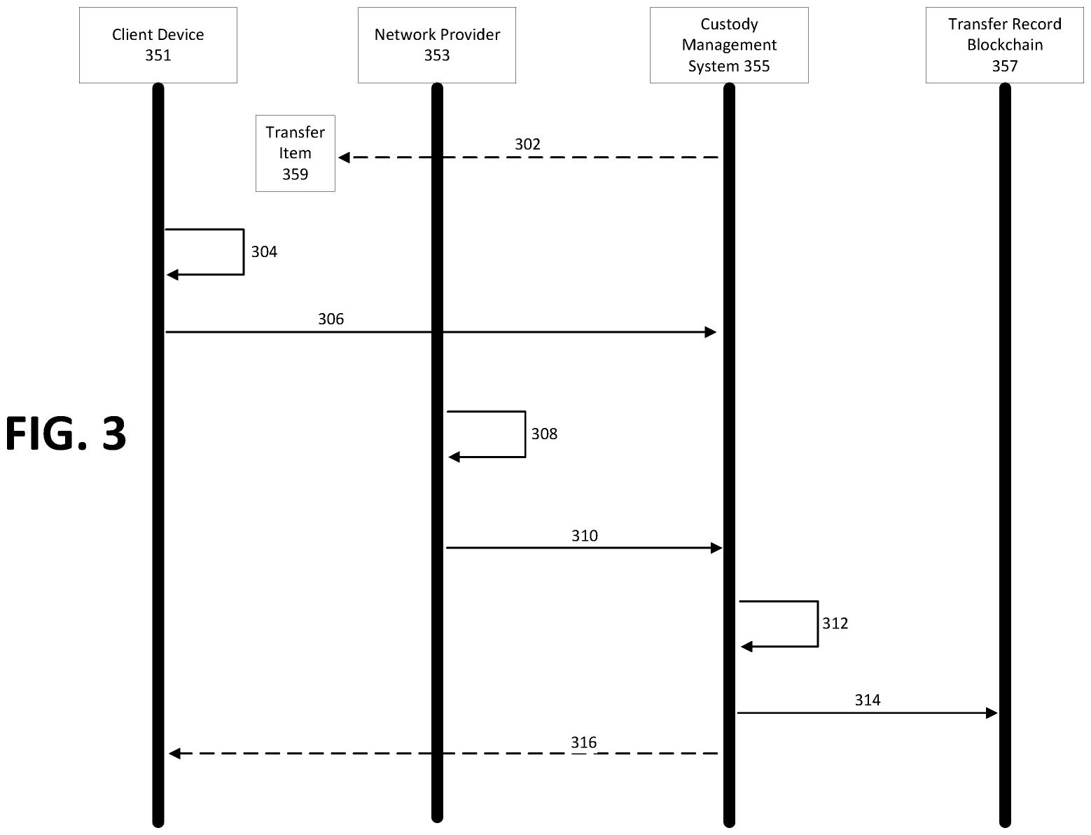

FIG. 3 illustrates a data flow diagram depicting example operations between devices, systems, and the like for frictionless custody chain management. Specifically, FIG. 3 illustrates a data flow between user device 351, network provider 353, custody management system 355, and managed transfer record blockchain 357, for frictionless custody chain management associated with a transfer item 359.

At optional step 302, the custody management system 355, alone or via network provider 353, configures the transfer item 359 for frictionless custody chain management. In this regard, the custody management system 355 may generate and/or assign a transfer item data object corresponding to the transfer item 359. Additionally or alternatively, the custody management system, alone or via network provider 353, may assign a network address, such as a particular transfer destination URL, associated with managing transfers of the transfer item 359. In some such embodiments, the transfer item data object including the network address, and/or a portion of the transfer item data object, may be physically provided with, printed on, and/or otherwise available associated with the transfer item 359.

In some such embodiments, information embodying the transfer item data object, network address, and/or other information used for custody chain management of the transfer item may be provided in an encoded format on, or otherwise associated with, the transfer item 359. For example, in some embodiments, the transfer item data object, network address, and/or other information used for custody chain management (e.g., user transfer request information) may be provided as a parseable image in an encoded format on or associated with the transfer item 359. In some embodiments, the parseable image is intended for capturing and parsing by a user via a client device upon receiving the transfer item in a transfer and/or other transaction. Non-limiting examples of such a parseable image include QR codes, barcodes, scannable text, and/or the like. For example, a QR code may be printed on, or embedded in, the transfer item 359, or in other example contexts printed on or embedded in tags, materials (e.g., documents, instruction manuals, receipts), or other physical materials associated with the transfer item 359. Additionally or alternatively, in some example contexts, the QR code (or other parseable image), for example, may be provided electronically, such as by accessing a webpage associated with the transfer item 359.

At step 304, the client device 351 receives user transfer request information associated with the transfer item 359. In some such embodiments, the client device 351 may receive the user transfer request information in response to user engagement with a specially programmed service application (e.g., a web application accessed via a browser app, executable app, or the like) executed via the client device 351. The user transfer request information may include a variety of information associated with the transfer item 359 and/or associated with frictionless custody chain management for the transfer item 359. For example, the user transfer request information may include information used to generate and/or transmit a corresponding custody transfer request data object and/or device identification information, including, without limitation, a transfer item data object (or transfer item data object identification information), transferor data object identification information, a transfer request destination URL, and/or the like.

In some embodiments, the client device 351 receives user engagement embodying manual user input of the user transfer request information. For example, a user of the client device 351 may manually input the user transfer request information, or a portion thereof such that the client device 351 may identify the remainder of the user transfer request information linked to the inputted portion of the user transfer request information, while reading the information from the transfer item 359 (or from associated material). Alternatively or additionally, the user of the client device 351 may engage the client device to activate one or more image capture devices, cameras, and/or the like, to capture an image for parsing. For example, via a specially programmed application executed on the client device 351, the user may engage the client device 351 to activate a camera to capture a parseable image for analysis by the client device 351 (e.g., subsequent parsing and/or decoding) to receive or otherwise identify the user transfer request information.

At step 306, the client device 351 generates and/or transmits a custody transfer request data object to the custody management system 355, via the network provider 353. In some embodiments, the client device 351 transmits the custody transfer request data object to a transfer request destination URL that the client device 351 identified from received user transfer request information. In some embodiments, the transfer request destination URL may be associated with a particular network device of the network provider 353, which is configured to forward the received custody transfer request data object to the custody management system 355. In yet some embodiments, the transfer request destination URL may be associated with a sub-device and/or sub-system of the custody management system 355. The custody transfer request data object may include some or all of the user transfer request information, and/or may include data identified based on the received user transfer request information (e.g., data retrieved from the client device 351 or another device, system, or the like communicable with the client device 351 based on the received user transfer request information).

The network provider 353 may include one or more network devices configured to perform one or more processes to identify device identification information for the client device associated with a received request, such as a request received and forwarded to the custody management system 355, or received by the custody management system 355 and forwarded to the network provider 353. In this regard, at step 308, the network provider 353 may detect or otherwise identify device identification information associated with the client device 351. In an example context, such as where the client device 351 is embodied by a mobile device, the device identification information may comprise a telephone number (in plain-text or hashed form) associated with the client device 351. The network provider 353, in such a context, may embody a carrier network associated with the client device 351, and may utilize one or more secure processes to identify the device identification information. In this context, for example, the network provider 353 may utilize a secure process for accessing the subscriber identity module (SIM) card, or virtual SIM or other technology, associated with the client device 351 to identify the device identification information. For example, in this context, the network provider 353 may utilize a process similar to the process used to identify the client device 351 for billing purposes. It should be appreciated that, in other contexts, the device identification information may comprise other information, including but not limited to an IP address, serial number, login information, and/or the like associated with the client device 351. Such other device identification information may be received through one or more other secure processes verifiable by the network provider 353, including but not limited to a header enrichment process, DAA process, login authentication process, and/or the like, such that the device identification information identified by the network provider 353 is considered trustworthy and associated with the client device 351.

At step 310, the network provider 353 may transmit the device identification information to the custody management system 355. In some embodiments, for example, the network provider 353 transmits the device identification information using a header enrichment process associated with the custody transfer request data object received from the client device 351, such that the custody management system 355 receives the custody transfer request data object with the device identification information “injected” by the network provider 353 into the transmission. Additionally or alternatively, in some embodiments, the network provider 353 may transmit the device identification information separately from forwarding the custody transfer request data object, and may transmit the device identification information along with data for associating the device identification information with the forwarded custody transfer request data object.

The network provide 353 may include one or more network devices configured to perform one or more secure processes to identify device identification information for a client device associated with a received request, such as the request received and forwarded to the custody management system 355, or received by the custody management system 355 and forwarded to the network provider 353 (or a device thereof). In this regard, at step 312, the custody management system 355 may associate device identification information with some or all of the received custody transfer request data object, or some or all of the transfer request information of a custody transfer request data object. In some embodiments, the custody transfer request data object is received with device identification information injected therein, for example via a header enrichment process, the custody management system 355 may identify the injected device identification information and associate it with some or all of the transfer request information in the custody transfer request data object. For example, the custody management system 355 may associate the device identification information with transfer item data object identification information, transferor data object identification information, and/or other information in the custody transfer request data object used for recording a transfer of transfer item 359.

It should be appreciated that, in some embodiments, the custody management system 355 may communicate with another third-party system to identify device identification information and/or authenticate device identification information. For example, the custody management system 355 may communicate with a third-party system controlled by a service provider associated with a particular electronically-delivered service. Alternatively, the custody management system 355 may communicate with a third-party system controlled by a device manufacturer, and/or provider of core functionality associated with the device (e.g., a software, firmware, and/or hardware producer that configures a device for consumer use). In this regard, in addition to or alternative to the network provider 353, the custody management system 355 may communicate with one or more other third-party systems for identifying device identification information through one or more secure authentication processes leveraging one or more trusted third-party system(s).

At step 314, the custody management system may generate and/or store a transfer record to one or more transfer record storages, such as the transfer record blockchain 357. The transfer record may comprise the associated information set generated by the custody management system 355, for example generated at the association step 312. In this regard, the client device 351 may be associated with a recipient user that received the transfer item 359 in a transfer, and thus the device identification information may embody, or be associated with and used to identify, a user account or identifier embodying a recipient data object for this transfer. The transfer record may further include a transfer data object, or transfer data object identification information, corresponding to the transfer object 359. The transfer record may further include a transferor data object, or transferor data object identification information, associated with or embodied by a portion of the associated information set. Alternatively, in some embodiments, the custody management system 355 may identify a transferor data object based on a most recent transfer record, retrieved from the transfer record blockchain 357, associated with the transfer item data object (or corresponding identification information) in the associated information set. It should be appreciated that, in some embodiments, the transfer record may include additional and/or alternative data and/or metadata, including but not limited to a transfer timestamp, a block hash for the new transfer record, an identification verification process identifier (e.g., identifying the particular process used to identify, detect, and/or verify the device identification information), captured image data associated with the custody transfer request data object, and/or the like.

At step 316, the custody management system may generate and/or transmit a transfer response data object to the client device 351. The transfer response data object may indicate whether the custody transfer request data object was successfully authenticated and/or processed, and/or whether a transfer record was successfully added to the transfer record blockchain 357. In some embodiments, the transfer response data object may embody a success message and/or indicator when a new transfer record was successfully stored to the transfer record blockchain 357. The transfer response data object may embody an error message and/or indicator when the custody management system 355 failed to authenticate device identification information and/or other authentication information received associated with the custody transfer request data object, or failed to store a new transfer record to the transfer record blockchain 357. The client device 351 may be configured to receive the transfer response data object, and perform one or more actions based on the transfer response data object and/or output one or more interfaces based on the transfer response data object (e.g., to render an interface indicating whether the custody transfer request data object was successfully processed).

In some embodiments, additional and/or alternative steps may be performed by embodiment systems described herein. In this regard, for example, the network provider 353 and/or custody management system 355 may perform one or more authentication steps not depicted in the illustrated data flow. Additionally or alternatively, in some embodiments, one or more of the depicted systems, devices, and/or the like, may be embodied by one or more sub-systems. For example, in some embodiments, the custody management system 355 may comprise an authentication server and a custody management server in communication with one another. Accordingly, it should be appreciated that the specific data flow illustrated with respect to FIG. 3 is an example and not to limit the scope or spirit of the disclosure herein.

### Example Custody Management System Performed Processes

Having described an example data flow between components of a system in accordance with example embodiments of the present disclosure, example computer-implemented processes will now be described. It will be appreciated that the computer-implemented processes may be executed by one or more of the systems depicted with respect to the data flow of FIG. 3, and/or in a myriad of ways using various system configurations.

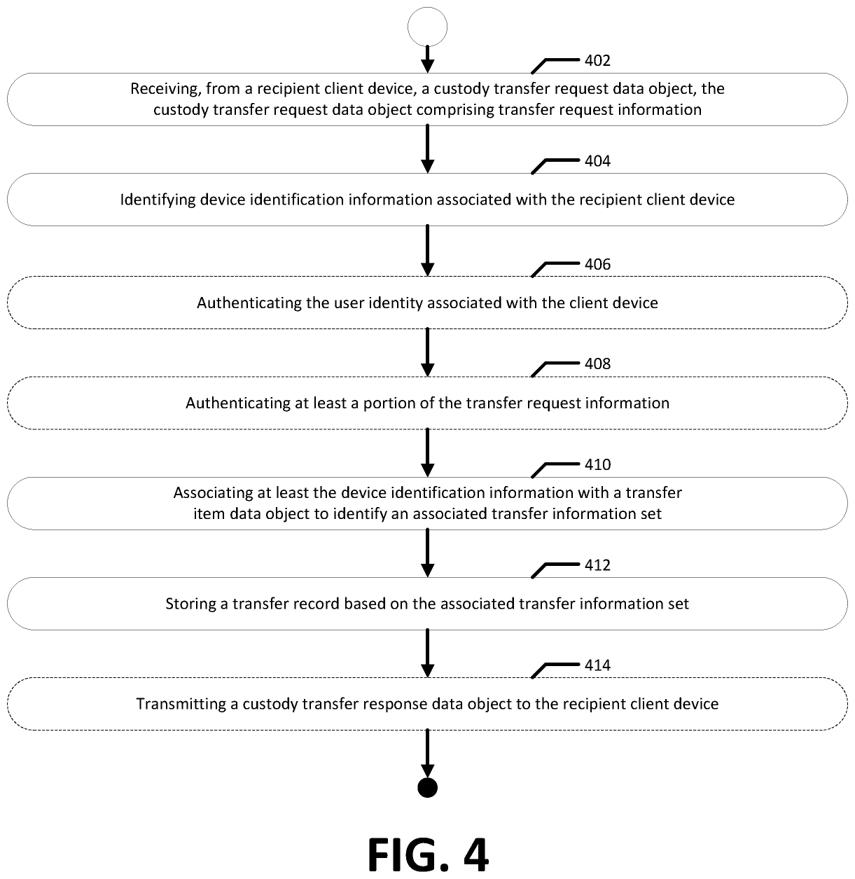

FIG. 4 illustrates an example process for frictionless custody chain management in accordance with example embodiments of the present disclosure. The example process may provide a computer-implemented method to be performed by specially configured hardware and/or software, for example performed by the apparatus 200A. The illustrated operations may, in some embodiments, be performed by the apparatus 200A in response to a client device receiving user transfer request information, for example user transfer request information manually input by a user of a recipient client device or automatically received in response to capture and/or processing of a parseable image, associated with a transfer item. For example, the recipient client device may be associated with a recipient user that received a transfer item during a transaction (e.g., a sale of a transfer item, transfer of a transfer item, gift of a transfer item, or the like).

At block 402, the apparatus 200A includes means, such as custody management module 212A, communications module 208A, processor 202A, and/or the like, or a combination thereof, configured to receive, from a recipient client device, a custody transfer request data object. The custody transfer request data object may comprise transfer request information for processing and/or storing to a transfer record. For example, the recipient client device may be associated with a recipient user that received, via a transfer, a transfer item associated with a transfer item data object. The transfer request information may include, without limitation, at least a transfer item data object (or corresponding transfer item data object identification information). In some embodiments, the transfer request information additionally includes a transferor data object (or corresponding transferor data object identification information), recipient data object (or corresponding recipient data object identification information), or the like the generating and/or storing a new transfer record. Additionally or alternatively, in some embodiments, the transfer request information includes information to authenticate the identity of the recipient client device and/or a corresponding user, for example device location data and/or device user biometric data.

At block 404, the apparatus 200A includes means, such as authentication module 210A, custody management module 212A, communications module 208A, processor 202A, and/or the like, or a combination thereof, configured to identify device identification information associated with the recipient client device. In some embodiments, the device identification information is identified using a header enrichment process, a DAA process, a user login process, and/or the like. In some embodiments, the apparatus 200A may identify the device identification information from the custody transfer request data object, for example where device identification information is injected into the custody transfer request data object forwarded to the apparatus 200A. In some such embodiments, the apparatus 200A communicates with a network device to identify the device identification information associated with the recipient client device.

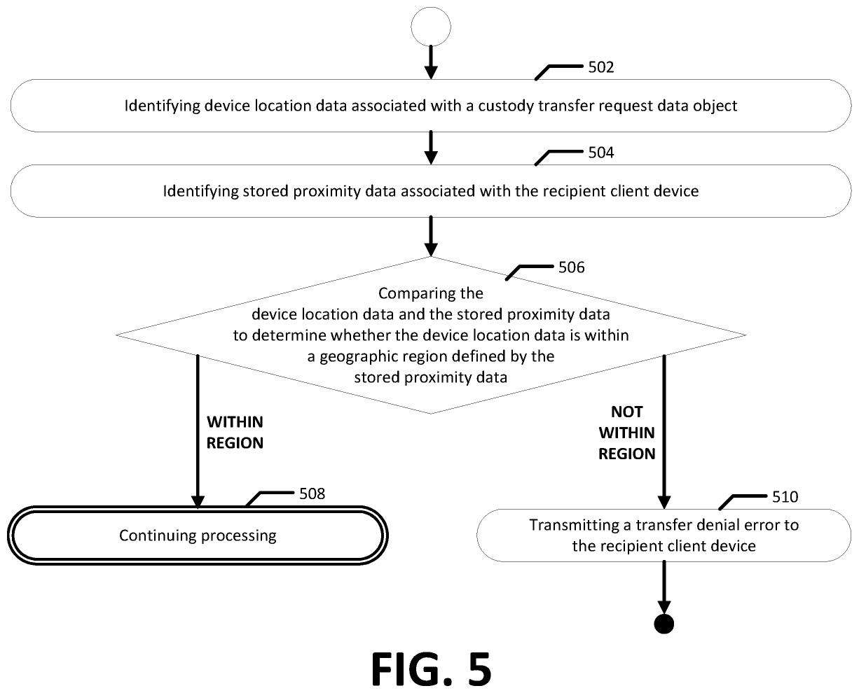

At optional block 406, the apparatus 200A includes means, such as authentication module 210A, custody management module 212A, communications module 208A, processor 202A, and/or the like, or a combination thereof, configured to authenticate the user identity associated with the client device. In some such embodiments, the apparatus 200A may be configured to authenticate the user identity using one or more authentication processes. For example, in some embodiments, the apparatus 200A may be configured to perform one or more of the processes described with respect to FIGS. 5-7. In this regard, the apparatus 200A may authenticate some or all of the received information, including device identification information and/or transfer request information from the received custody transfer request data object, to authenticate the user identity associated with the client device (e.g., authenticate the user is who they claim to be, authenticate the user has access to the client device, and/or authenticate the client device is the device it asserts to be). In some such embodiments, the apparatus 200A may be configured to retrieve stored information used to authenticate received and/or otherwise identified information. In some such embodiments, in a circumstance where the apparatus 200A fails to authenticate the user identity associated with the client device, the apparatus 200A may generate a transfer denial error and provide the transfer denial error to the recipient client device as a custody transfer response data object, ending the flow.

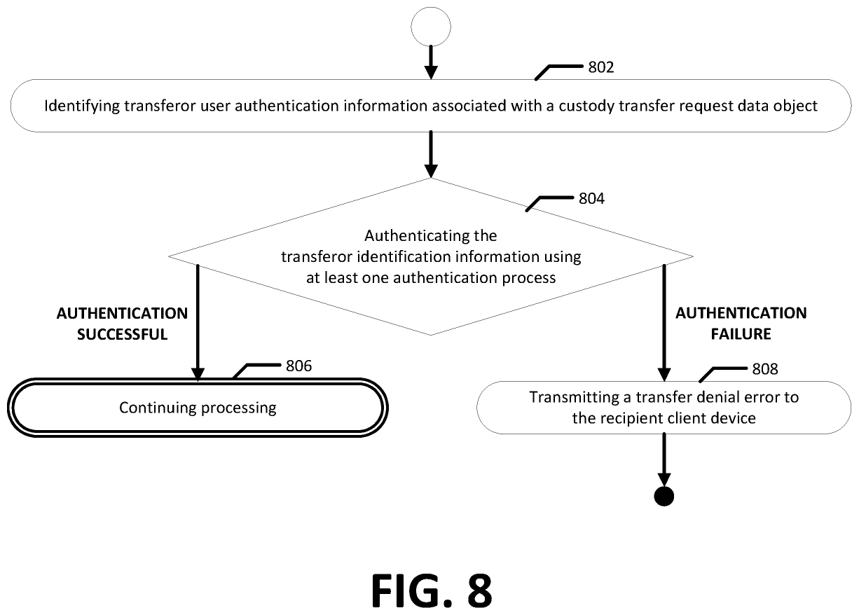

At optional block 408, the apparatus 200A includes means, such as authentication module 210A, custody management module 212A, communications module 208A, processor 202A, and/or the like, or a combination thereof, configured to authenticate at least a portion of the transfer request information. For example, in some embodiments, the apparatus 200A may be configured to authenticate the identity of a transferor user, who may be associated with a second client device, and/or authenticate that a transferor data object associated with a transferor user is currently indicated as a recorded possessor data object for a particular transfer item data object. In this regard, for example in some embodiments, the apparatus 200A may be configured to perform the process described with respect to FIG. 8. In some such embodiments, in a circumstance where the apparatus 200A fails to authenticate some or all of the portion of the transfer request information, the apparatus 200A may generate a transfer denial error and provide the transfer denial error to the recipient client device as a custody transfer response data object, ending the flow.

Additionally or alternatively, in some embodiments, the apparatus 200A may communicate with an authentication server to authenticate the user identity associated with the recipient client device and/or a transferor data object. In some such embodiments, the apparatus 200A may be configured to transmit a portion of the transfer request information to the authentication server for processing, and/or device identification information for processing. In an example context, the authentication server may be configured to perform one or more authentication processes and send a signal to the apparatus 200A abased on the results of the authentication process(es). For example, the apparatus 200A may receive a termination signal from the authentication server in a circumstance where one or more authentication processes failed, or a continuation signal in a circumstance where all authentication processes succeeded. It should be appreciated that, in some embodiments, the apparatus 200A may suspend processing at block 410 until a signal is received from the authentication server indicating that authentication was successful.

At block 410, the apparatus 200A includes means, such as custody management module 212A, processor 202A, and/or the like, or a combination thereof, configured to associate at least the device identification information with a transfer item data object. In some embodiments, additionally or alternatively, a portion of the custody transfer request data object (e.g., at least a portion of the transfer request information and/or a portion of metadata) is associated with the transfer item data object and device identification information to identify the associated transfer information set. In this regard, in some embodiments, the transfer item data object is identified and/or retrieved based on a portion of the transfer request information, such as transfer item data object identification information included and parsed from the transfer request information. Additionally or alternatively, the transfer item data object may be identified based on other information included in the transfer request information, and/or a combination of the transfer request information and the device identification information.

Additionally or alternatively to associating the device identification information and transfer item data object, in some embodiments the apparatus 200A may associate the device identification information and transfer item data object with at least a portion of the transfer request information to identify an associated transfer information set. In some embodiments, for example where the device identification information is injected into the custody transfer request data object via a header enrichment process, the device identification information may be associated with particular information from the associated custody transfer request data object used to generate the corresponding transfer report data object. In other embodiments, the apparatus 200A may receive and/or identify, for example from a network device or third-party system, an identifier for associating device identification information with a specific custody transfer request data object and/or portion of transfer request information. For example, in some embodiments, the apparatus 200A generates and/or assigns a session or transfer identifier to the received custody transfer request data object, and communicates with a network device and/or third-party system to receive device identification information specifically associated with the session or transfer identifier, such that the session or transfer identifier may be used to associate the device identification information with a relevant portion of the transfer request information of the custody transfer request data object. In some embodiments, the resulting associated transfer information set includes the device identification information and all other data required for generating a transfer record data object that summarizes the transfer identified as associated with the custody transfer request data object.

At block 412, the apparatus 200A includes means, such as custody management module 212A, processor 202A, and/or the like, or a combination thereof, configured to store a transfer record based on the associated transfer information set, for example to at least one transfer record storage. In some embodiments, the transfer record storage may be embodied by at least one centralized and/or distributed database maintained by or accessible to the apparatus 200A. Additionally or alternatively, in some embodiments, the transfer record storage may be embodied by at least a transfer record blockchain manageable via the apparatus 200A. It should be appreciated that, in some embodiments, the apparatus 200A may store the transfer record in a plurality of storage types, for example in one or more databases, repositories, blockchains, or any combination thereof.

In some embodiments, the apparatus 200A is configured to generate the transfer record based on the associated information set. The transfer record, in some embodiments, comprises at least a portion of the associated transfer information set. For example, in some embodiments, the apparatus 200A generates a transfer record including at least the transfer item data object identification information and/or recipient data object identification information, parsed from the associated transfer information set. In some such embodiments, the recipient data object identification information comprises the device identification information, or a user account associated with the device identification information and maintained by the apparatus 200A, such that each recipient data object is associated with verifiable device identification information that can be authenticated as associated with a particular client device and/or user identity. The transfer item data object identification information may include a transfer item identifier associated with a transfer item data object associated with a transfer item. The transfer record may, additionally or alternatively, include one or more additional data fields, metadata (e.g., transfer timestamp) from the associated transfer information set and/or custody transfer request data object, and/or the like.

To store the transfer report in a transfer report database, the apparatus 200A may update one or more tables based on the transfer record, such that the transfer record may be retrieved from the transfer report database using any combination of information included in the transfer record, such as, without limitation, (1) an identifier associated with the transfer report, (2) the device identification information, (3) transfer item data object identification information associated with (or included in) the transfer record, or (4) any combination thereof. To store the transfer report in a transfer report blockchain, the apparatus 200A may be configured to generate a storage identifier, such as a block hash for the new transfer record, and append the transfer report to the transfer report blockchain. The transfer report blockchain may be queried by the apparatus 200A, one or more client device(s), and/or one or more other networked devices, to identify transfer records associated with particular device identification information, a particular transfer item data object, or the like. It should be appreciated that, in some embodiments, the transfer report blockchain comprises a private blockchain, hybrid blockchain, or modified public blockchain, or other implementation such that the apparatus 200A has permissions to add to the transfer record blockchain. The transfer report blockchain may be readable only by the apparatus 200A, or indirectly by one or more client devices (e.g., through a request transmitted to the apparatus 200A) or directly by one or more client devices (e.g., in a distributed manner, for example). It should be appreciated that as a new transfer record is appended to the transfer report blockchain, that transfer report becomes the most recent transfer report that corresponds to the transfer item data object associated with the newly added transfer report. As such, at any one time, the recorded possessor data object associated with a particular transfer item data object may be based on the most recent recipient data object as identified in the most recent transfer report.

At optional block 414, the apparatus 200A includes means, such as authentication module 210A, custody management module 212A, processor 202A, and/or the like, or a combination thereof, configured to transmit a custody transfer response data object to the recipient client device. The custody transfer response data object may comprise and/or embody an indication of whether all authentication processes were successfully completed, and the new transfer report was successfully stored. For example, the custody transfer response data object may embody a transfer denial error where one or more authentication processes failed, and may comprise an error message indicating the reason for such failure (e.g., the user's identity or client device identity could not be authenticated, the transferor data object indicated by the custody transfer request data object is not the recorded possessor data object, failed to add the new transfer record to the transfer record blockchain, or the like). Alternatively, the custody transfer response data object may embody or comprise a transfer success message upon successful storage of the new transfer report.

FIG. 5 illustrates one example authentication process that may be used in some embodiments to facilitate frictionless custody chain management. For example, in some embodiments, the process described with respect to FIG. 5 may embody a sub-process for performance as one authentication process in authentication of a user identity associated with a client device, for example at block 406 of the process depicted with respect to FIG. 4. It should be understood that, in some embodiments, the authentication process described with respect to FIG. 5 may be combined with one or more authentication processes with associated operations performed in any combination, order, and/or the like. The example process may provide a specific computer-implemented method to be performed by specially configured hardware and/or software, for example performed by the apparatus 200A.

At block 502, the apparatus 200A includes means, such as authentication module 210A, custody management module 212A, processor 202A, and/or the like, or a combination thereof, configured to identify device location data associated with custody transfer request data object. The custody transfer request data object may have been received at an earlier block. In some embodiments, the apparatus 200A is configured to parse device location data transmitted as transfer request information within the custody transfer request data object. Additionally or alternatively, in some embodiments, the apparatus 200A may identify information from the custody transfer request data object, for example IP address information or other information identifying the client device associated with the custody transfer request data object, to request and receive device location data from the client device. It should be appreciated that the device location data may be in any of a myriad of formats and embody a myriad of location types, for example, without limitation, a latitude and longitude coordinate, triangulation data from a network provider or another entity associated with the client device, an address, a zip code, a region-identifier determined by the apparatus 200A based on one or more previous actions, and/or the like. The device location data, in some embodiments, may be stored by the client device, and retrieved for transmission to the apparatus 200A. Additionally or alternatively, in some embodiments, the apparatus 200A may detect, collect, and/or transmit the device location data in real-time, for example using location services hardware and/or software associated with the client device.

At block 504, the apparatus 200A includes means, such as authentication module 210A, custody management module 212A, processor 202A, and/or the like, or a combination thereof, configured to identify stored proximity data associated with the recipient client device. The stored proximity data may include data representing one or more geographic areas such that a client device is authenticated if device location associated with the client device is within one of the geographic areas. For example, in some embodiments, the stored proximity data may include an approved location indicator and a radius, such that the stored proximity data represents a certain radius around the approved location. Additionally or alternatively, in some embodiments, the stored proximity data comprises a plurality of location boundary data objects, such that the stored proximity data represents an enclosed geographic area defined by the plurality of location boundary data objects.

In some embodiments, to identify the stored proximity data associated with the recipient client device, the apparatus 200A is configured to retrieve the stored proximity data from a database or other repository. The stored proximity data may be retrieved based on the device identification information, for example where the stored proximity data is stored to a database associated with certain device identification information. In some embodiments, the apparatus 200A generates the stored proximity data associated with particular device identification information based on the device location data for one or more previously received custody transfer request data objects. In other embodiments, a user may configure and/or otherwise submit proximity data to be stored associated with the device identification information, or the like.

In some such embodiments, the apparatus 200A identifies stored proximity data using one or more database queries. For example, in some embodiments, the apparatus 200A is configured to query a proximity data database using identified device identification information and/or other information received and/or associated with a custody transfer request data object. The apparatus 200A may, in response to the query, receive result data including the stored proximity data associated with the device identification information, and therefore associated with the recipient client device.

At determination block 506, the apparatus 200A includes means, such as authentication module 210A, custody management module 212A, processor 202A, and/or the like, or a combination thereof, configured to compare the device location data and the stored proximity data to determine whether the device location data is within a geographic region defined by the stored proximity data. In some embodiments, the apparatus 200A may utilize one or more application programming interfaces (APIs) to compare the device location data and the stored proximity data, wherein such one or more API(s) are configured to output the determination. Alternatively, in some embodiments, the apparatus 200A is configured to perform one or more range checks, for example a range check between the device location data and location data include in the stored proximity data, to output the determination as to whether the device location data satisfies a range threshold included in or associated with the geographic area defined by the stored proximity data (for example, the device location data is within the geographic area if less than the range threshold distance from a particular stored location). It should be appreciated that, in other embodiments, one or more additional and/or alternative algorithms may be used to determine whether the device location data is within the geographic region defined by the stored proximity data.

If, at block 506, the apparatus 200A determines the device location data is not within the geographic region defined by the stored proximity data, flow continues to block 510. At block 510, the apparatus 200A includes means, such as authentication module 210A, custody management module 212A, processor 202A, and/or the like, or a combination thereof, configured to transmit a transfer denial error to the recipient client device. The transfer denial error may be embodied by, or include, an indication that the device location data is not within the geographic region defined by the stored proximity data. In some embodiments, the indication is embodied by a single number, letter, or other interpretable data value that is interpreted by the client device as associated with a particular failed authentication process (e.g., error number 1 corresponds to failed location authentication). Additionally or alternatively, transfer denial error may include an error message, for example indicating that the device is not located in a trusted location, or that user authentication has failed generally. The transfer denial error may be transmitted to the client device as part of a custody transfer response data object transmitted in response to an earlier received custody transfer request data object.

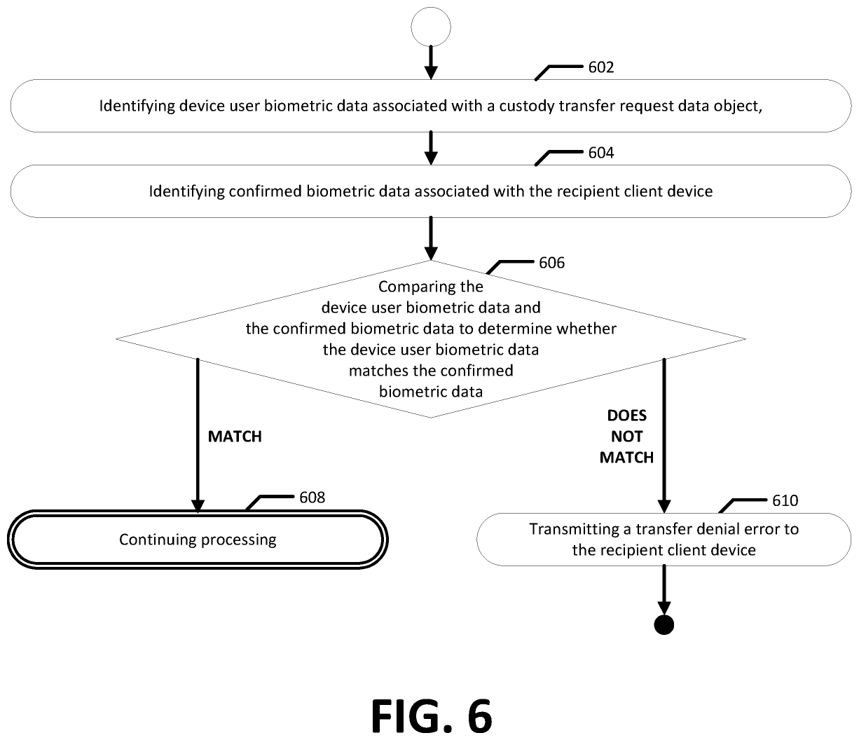

Returning to block 506, if, at block 506, the apparatus 200A determines the device location data is within the geographic region defined by the stored proximity data, the apparatus 200A may continue processing the custody transfer request data object at block 508. In some contexts, to cause processing to continue, the apparatus 200A may generate and/or transmit a continuation signal, for example to one or more sub-systems and/or associated systems. In some embodiments, the apparatus 200A generates and/or transmits a continuation signal upon completion of all authentication processes. In some embodiments, the apparatus 200A may proceed to one or more other authentication processes, for example those represented in FIGS. 6-8. Alternatively, in some embodiments, the apparatus 200A subsequently executes one or more other operations for processing a custody transfer request data object. For example, the apparatus 200A may continue performing one or more operations described above with respect to FIG. 4.

The determination may indicate if the client device, and thereby the user, is located at a particular trusted location. For example, the stored proximity data may define a geographic region around a home address for a particular user associated with the client device, work address for the particular user associated with the client device, or the like. Additionally or alternatively, the stored proximity data may define a geographic region around a business and/or location where the client device is expected to be located (for example, where the client device is a business terminal located or associated with a particular business location). In this regard, the determination may improve system security by preventing processing of false requests transmitted by users accessing client devices in untrusted locations.

FIG. 6 illustrates yet another example authentication process that may be used in some embodiments to facilitate frictionless custody chain management. For example, in some embodiments, the process described with respect to FIG. 6 may embody a sub-process for performance as one authentication process in authentication of a user identity associated with a client device, for example at block 406 of the process depicted with respect to FIG. 4. It should be understood that, in some embodiments, the authentication process described with respect to FIG. 6 may be combined with one or more authentication processes with associated operations performed in any combination, order, and/or the like. The example process may provide a specific computer-implemented method to be performed by specially configured hardware and/or software, for example performed by the apparatus 200A.

At block 602, the apparatus 200A includes means, such as authentication module 210A, custody management module 212A, processor 202A, and/or the like, or a combination thereof, configured to identify device user biometric data associated with a custody transfer request data object. The custody transfer request data object may have been received at an earlier block. In some embodiments, the apparatus 200A is configured to parse the device user biometric data from transfer request information within the custody transfer request data object. Additionally or alternatively, in some embodiments, the apparatus 200A may identify information from the custody transfer request data object, for example IP address information or other information identifying the client device associated with the custody transfer request data object, to request and receive device user biometric data from the client device. It should be appreciated that the device user biometric data may be any of a myriad of biometrics associated with a user, for example and without limitation, fingerprint data, face scan data, iris scan data, walking gait data, passcode data, pass pattern data, voice data, and/or the like. Additionally or alternatively, in some embodiments, the apparatus 200A may capture, retrieve, and/or transmit the device user biometric data in real-time, for example using one or more hardware components associated with the client device (e.g., a fingerprint scanner, face scanner, microphone, and/or the like). In some embodiments, the device user biometric data may be encrypted, hashed, and/or otherwise transformed from a raw format such that user privacy associated with the device user biometric data is enhanced.

At block 604, the apparatus 200A includes means, such as authentication module 210A, custody management module 212A, processor 202A, and/or the like, or a combination thereof, configured to identify confirmed biometric data associated with the recipient client device. The confirmed biometric data may include data representing one or more biometric features associated with an authenticated user of the recipient client device. The confirmed biometric data may be received by the client device and/or otherwise provisioned by a user at a previous block.

In some embodiments, to identify the confirmed biometric data associated with the recipient client device, the apparatus 200A is configured to retrieve the confirmed biometric data from a database or other repository. The apparatus 200A may include one or more databases configured to store confirmed biometric data, for example a dedicated confirmed biometric database or a single database configured for storing multiple authentication data types (e.g., confirmed biometric data and stored proximity data). The confirmed biometric data may be retrieved based on the device identification information, for example where the confirmed biometric data is stored to a database associated with specific device identification information. In some embodiments, the apparatus 200A stores confirmed biometric data associated with particular device identification information based on the device user biometric data for one or more previously received custody transfer request data objects. In other embodiments, a user may configure and/or otherwise submit confirmed biometric data to be stored associated with the device identification information, or the like.

In some such embodiments, the apparatus 200A identifies confirmed biometric data using one or more database queries. For example, in some embodiments, the apparatus 200A is configured to query a confirmed biometric database using the identified device identification information and/or other information received and/or associated with a custody transfer request data object. The apparatus 200A may, in response to the query, receive result data including the confirmed biometric data associated with the device identification information, and therefore associated with the recipient client device.

At determination block 606, the apparatus 200A includes means, such as authentication module 210A, custody management module 212A, processor 202A, and/or the like, or a combination thereof, configured to compare the device user biometric data and the confirmed biometric data to determine whether the device user biometric data matches the confirmed biometric data. In some such embodiments, the apparatus 200A is configured to perform a direct comparison between the device user biometric data and confirmed biometric data. In other embodiments, the apparatus 200A is configured to perform one or more un-encryption or other transformation operations on the device user biometric data and/or confirmed biometric data before comparing. Alternatively or additionally, in some embodiments, the apparatus 200A may implement one or more APIs for performing the comparison between the device user biometric data and the confirmed biometric data. The apparatus 200A may, in some embodiments, implement various comparison algorithms for biometric data of different types (e.g., a first comparison for fingerprint data, a second comparison for voice data, and/or the like).

If, at block 606, the apparatus 200A determines the device user biometric data does not match the confirmed biometric data, flow continues to block 610. At determination block 610, the apparatus 200A includes means, such as authentication module 210A, custody management module 212A, processor 202A, and/or the like, or a combination thereof, configured to transmit a transfer denial error to the recipient client device. The transfer denial error may be embodied by, or include, an indication that the device user biometric data does not match the confirmed biometric data. In some embodiments, the indication is embodied by a single number, letter, or other interpretable data value that is interpreted by the client device as associated with a particular failed authentication process (e.g., error number 2 corresponds to failed biometric authentication). Additionally or alternatively, the transfer denial error may include an error message, for example indicating that the particular biometric data captured did not match confirmed biometric data, or that user authentication has failed generally. The transfer denial error may be transmitted to the client device as part of a custody transfer response data object transmitted in response to an earlier received custody transfer request data object.

Returning to block 606, if, at block 606, the apparatus 200A determines the device location data is within the geographic region defined by the stored proximity data, the apparatus 200A may continue processing the custody transfer request data object at block 608. In some contexts, to cause processing to continue, the apparatus 200A may generate and/or transmit a continuation signal, for example to one or more sub-systems and/or associated systems. In some embodiments, the apparatus 200A generates and/or transmits a continuation signal upon completion of all authentication processes. In some embodiments, the apparatus 200A may proceed to one or more other authentication processes, for example those represented in FIG. 5, 7, or 8. Alternatively, in some embodiments, the apparatus 200A subsequently executes one or more other operations for processing a custody transfer request data object. For example, the apparatus 200A may continue performing one or more operations described above with respect to FIG. 4.

The determination may indicate if the user identity is an expected and/or authenticated user. For example, the confirmed biometric data may be associated with an owner and/or authorized user of the recipient client device, such that only such person(s) can submit one or more custody transfer request data object(s) for processing via that client device. In this regard, the determination may improve system security by preventing processing of false requests transmitted by users not authenticated to utilize a particular client device.

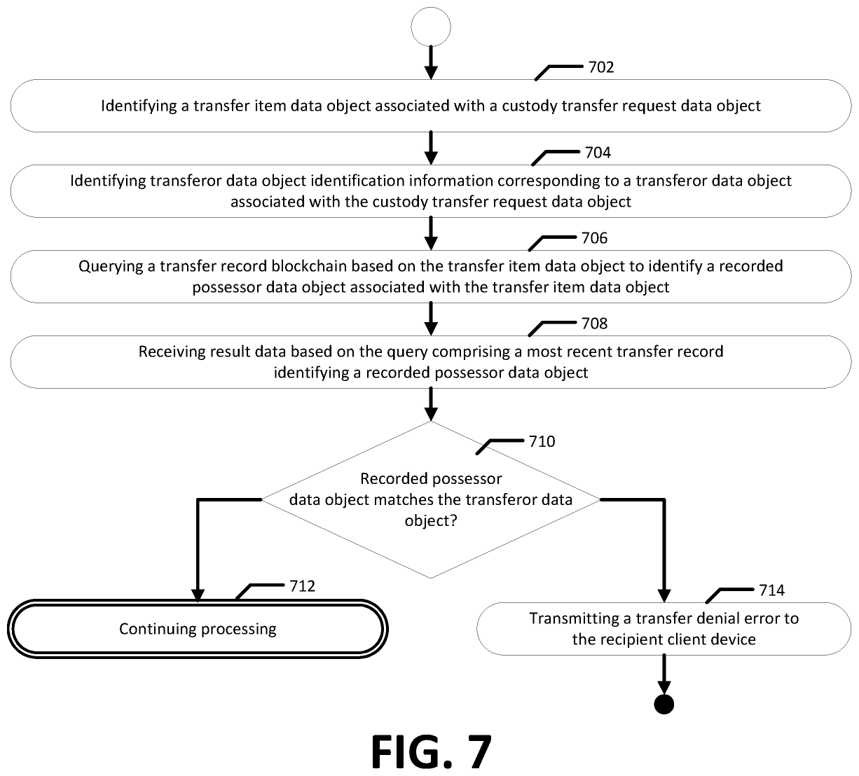

FIG. 7 illustrates yet another example authentication process that may be used in some embodiments to facilitate frictionless custody chain management. For example, in some embodiments, the process described with respect to FIG. 7 may embody a sub-process for performance as one authentication process in authentication of a portion of received transfer request information, such as transfer request information associated with or included within a received custody transfer request data object, for example at block 408 of the process depicted with respect to FIG. 4. It should be understood that, in some embodiments, the authentication process described with respect to FIG. 7 may be combined with one or more authentication processes with associated operations performed in any combination, order, and/or the like. The example process may provide a specific computer-implemented method to be performed by specially configured hardware and/or software, for example performed by the apparatus 200A.

At block 702, the apparatus 200A includes means, such as authentication module 210A, custody management module 212A, processor 202A, and/or the like, or a combination thereof, configured to identify transfer a transfer item data object associated with custody transfer request data object. The custody transfer request data object may have been received at an earlier block. In some embodiments, the apparatus 200A is configured to parse transfer item data object identification information from transfer request information within the custody transfer request data object. The transfer item data object identification information may be used by the apparatus 200A to identify a corresponding transfer item data object. The transfer item data object may represent a particular transfer item being transferred to the recipient user associated with the recipient client device. In some such embodiments, the received custody transfer request data object includes transfer request information captured and/or parsed from a parseable image, such as a QR code, printed on, imprinted to, attached to, or otherwise associated with the transfer item

At block 704, the apparatus 200A includes means, such as authentication module 210A, custody management module 212A, processor 202A, and/or the like, or a combination thereof, configured to identify transferor data object identification information associated with the custody transfer request data object. In some embodiments, the apparatus 200A is configured to parse the transferor data object identification information from the transfer request information within the custody transfer request data object. Additionally or alternatively, in some embodiments, the apparatus 200A may receive the transferor data object identification information associated with the custody transfer request data object, for example from a second client device associated with a transferor user. In this regard, the transferor data object identification information may be transmitted to the apparatus 200A together with a session and/or transfer identifier associated with the custody transfer request data object, such that the transferor data object identification information can be associated with the corresponding custody transfer request data object. Additionally or alternatively, in some embodiments, the apparatus 200A may identify information from the custody transfer request data object, for example IP address information or other information used in identifying a second client device associated with a transferor user associated with the custody transfer request data object, to request and receive transferor data object identification information from the second client device. It should be appreciated that the transferor data object identification information may embody device identification information associated with a second client device for a transferor user and/or associated with the corresponding transferor data object.

At block 706, the apparatus 200A includes means, such as authentication module 210A, custody management module 212A, processor 202A, and/or the like, or a combination thereof, configured to query a transfer record blockchain based on the transfer data object to identify a recorded possessor data object associated with the transfer item data object. In some such embodiments, the apparatus 200A may query the transfer record blockchain, using the transfer item data object and/or corresponding identification information, to identify a most recent transfer record associated with the transfer item data object. The most recent transfer record may embody information associated with the previous transfer performed between users of the system. The most recent transfer record may, for example, include information identifying the transferor data object and recipient data object for the last performed transfer. In this regard, the apparatus 200A may identify the recipient data object for the last performed transfer (as identified in the most recent transfer record) as the recorded possessor data object, as this information is associated with the user that last received the transfer item and thus should still possess it

At block 708, the apparatus 200A includes means, such as authentication module 210A, custody management module 212A, processor 202A, and/or the like, or a combination thereof, configured to receive result data based on the query. The results data may include a most recent transfer record associated with a transfer item data object. In this regard, the recipient data object for the most recent transfer report may be identified as the recorded possessor data object. In some circumstances, such as where no transfers have occurred for a transfer item data object, the result data may be empty or null. Alternatively, a transfer record may be retrieved that indicates the origin of the transfer item data object (e.g., in some embodiments, indicated by a transfer record with no transferor data object indicated).

At block 710, the apparatus 200A includes means, such as authentication module 210A, custody management module 212A, processor 202A, and/or the like, or a combination thereof, configured to determine whether the recorded possessor data object matches the transferor data object for the custody transfer request data object being processed. In some such embodiments, the apparatus 200A may compare identification information (e.g., one or more identifiers) for the recorded possessor data object and for the transferor data object. In this regard, the apparatus 200A is configured to determine whether the transferor associated with the current transfer (e.g., associated with the custody transfer request data object) is the most recent recorded possessor, or if the transferor is perhaps a fraudulent user.

If, at block 710, the apparatus 200A determines the recorded possessor data object does not match the transferor data object, flow continues to block 714. At block 714, the apparatus 200A includes means, such as authentication module 210A, custody management module 212A, processor 202A, and/or the like, or a combination thereof, configured to transmit a transfer denial error to the recipient client device. The transfer denial error may be embodied by, or include, an indication that the recorded possessor data object does not match the transferor data object. In some embodiments, the indication is embodied by a single number, letter, or other interpretable data value that is interpreted by the client device as associated with a particular failed authentication process (e.g., error number 3 corresponds to recorded possessor authentication). Additionally or alternatively, the transfer denial error may include an error message, for example indicating that the transferor user associated with the custody transfer request data object is not the recorded possessor, or that user authentication has failed generally. The transfer denial error may be transmitted to the client device as part of a custody transfer response data object transmitted in response to an earlier received custody transfer request data object.

Returning to block 710, if, at block 710, the apparatus 200A determines the recorded possessor data object matches the transferor data object for the custody transfer request data object, the apparatus 200A may continue processing the custody transfer request data object at block 712. In some contexts, to cause processing to continue, the apparatus 200A may generate and/or transmit a continuation signal, for example to one or more sub-systems and/or associated systems. In some embodiments, the apparatus 200A generates and/or transmits a continuation signal upon completion of all authentication processes. In some embodiments, the apparatus 200A may proceed to one or more other authentication processes, for example those represented in FIG. 5, 6, or 8. Alternatively, in some embodiments, the apparatus 200A subsequently executes one or more other operations for processing a custody transfer request data object. For example, the apparatus 200A may continue performing one or more operations described above with respect to FIG. 4.

The determination may indicate whether the transfer item is being transferred from a transferor user that rightfully possesses the transfer item based on previous transfer records. For example, where the most recent transfer record for a transfer item indicates a particular user most recently took possession of the transfer item, the apparatus 200A may be configured to only process a custody transfer request data object that indicates the transfer item was received from that user. In this regard, the apparatus 200A may reject any other custody transfer request data object(s).

FIG. 8 illustrates yet another example authentication process that may be used in some embodiments to facilitate frictionless custody chain management. For example, in some embodiments, the process described with respect to FIG. 8 may embody a sub-process for performance as one authentication process in authentication of a portion of received transfer request information, such as transfer request information associated with or included within a received custody transfer request data object, for example at block 408 of the process depicted with respect to FIG. 4. It should be understood that, in some embodiments, the authentication process described with respect to FIG. 8 may be combined with one or more authentication processes with associated operations performed in any combination, order, and/or the like. The example process may provide a specific computer-implemented method to be performed by specially configured hardware and/or software, for example performed by the apparatus 200A.

At block 802, the apparatus 200A includes means, such as authentication module 210A, custody management module 212A, processor 202A, and/or the like, or a combination thereof, configured to identify transferor user authentication information associated with a custody transfer request data object. The custody transfer request data object may have been received at an earlier block. In some embodiments, the apparatus 200A is configured to parse the transferor user authentication information from transfer request information within the custody transfer request data object. Additionally or alternatively, in some embodiments, the apparatus 200A may receive the transferor user authentication information associated with the custody transfer request data object, for example from a second client device associated with a transferor user. In this regard, the transferor user authentication information may be transmitted to the apparatus 200A together with a session and/or transfer identifier associated with the custody transfer request data object, such that the transferor user authentication information can be associated with the corresponding custody transfer request data object. Additionally or alternatively, in some embodiments, the apparatus 200A may identify information from the custody transfer request data object, for example IP address information or other information used in identifying a second client device associated with a transferor user associated with the custody transfer request data object, to request and receive transferor user authentication information from the second client device. It should be appreciated that the transferor user authentication information may embody device identification information associated with a second client device for a transferor user and/or associated with a corresponding transferor data object, and/or any of information for identifying the identity of the second client device and/or user associated with the second client device (e.g., device user biometric data for the transferor user, device location data for the second client device, authentication credentials for the transferor user, and/or the like).

At block 804, the apparatus 200A includes means, such as authentication module 210A, custody management module 212A, processor 202A, and/or the like, or a combination thereof, configured to authenticate the transferor user authentication information using at least one authentication process. In this regard, the transferor user authentication information may be authenticated using one or more of the processes identified and described with respect to FIG. 5, 6, or 7, or any combination thereof. It should be appreciated that, in some embodiments, the transferor user authentication information may include multiple information types, such that various data is used in various authentication processes.

If, at block 804, the apparatus 200A determines that one or more of the authentication processes has failed, flow continues to block 808. At block 808, the apparatus 200A includes means, such as authentication module 210A, custody management module 212A, processor 202A, and/or the like, or a combination thereof, configured to transmit a transfer denial error to the recipient client device. The transfer denial error may be embodied by, or include, an indication that one or more authentication processes associated with the transferor user authentication information failed. In some embodiments, the indication is embodied by a single number, letter, or other interpretable data value that is interpreted by the client device as associated with a particular failed authentication process (e.g., error number 4 corresponds to failed authentication of the transferor identity). Additionally or alternatively, the transfer denial error may include an error message, for example indicating that the transferor user authentication information could not be verified, or that transfer request information authentication has failed generally. The transfer denial error may be transmitted to the client device as part of a custody transfer response data object transmitted in response to an earlier received custody transfer request data object.

Returning to block 804, if, at block 804, the apparatus 200A successfully authenticates the transferor user authentication information using one or more authentication processes, the apparatus 200A may continue processing the custody transfer request data object at block 806. In some contexts, to cause processing to continue, the apparatus 200A may generate and/or transmit a continuation signal, for example to one or more sub-systems and/or associated systems. In some embodiments, the apparatus 200A generates and/or transmits a continuation signal upon completion of all authentication processes. In some embodiments, the apparatus 200A may proceed to one or more other authentication processes, for example those represented in FIG. 5, 6, or 7. Alternatively, in some embodiments, the apparatus 200A subsequently executes one or more other operations for processing a custody transfer request data object. For example, the apparatus 200A may continue performing one or more operations described above with respect to FIG. 4.

The operations described enable the apparatus 200A to terminate processing unless the identity of the transferor is validated, indicating the transferor is who they claim to be (in other words, and not a malicious user). For example, the recipient user may input transferor user authentication information associated with the transferor user, and/or the apparatus 200A may identify such information, for authentication so that transfers only are processed when both sides of the transfer have been authenticated. In this regard, the determination may improve system security by preventing processing of fraudulent requests transmitted by a user falsely operating as another user.

### Example Client Device Performed Processes

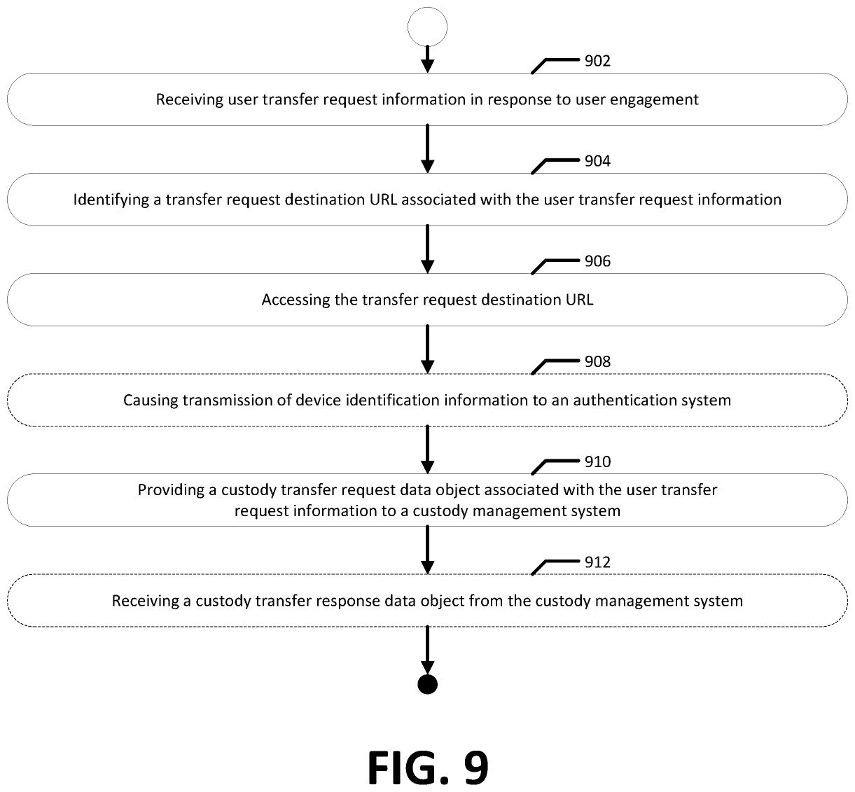

FIG. 9 illustrates an example process for frictionless custody chain management in accordance with example embodiments of the present disclosure. The example process may provide a computer-implemented method to be performed by specially configured hardware and/or software, for example performed by the apparatus 200B. The illustrated operations, in some embodiments, may be performed by the apparatus 200B in response to user engagement associated with transfer of a transfer item, and/or to initiate generation and/or transmission of a corresponding custody transfer request data object. For example, the apparatus 200B may embody a specially configured client device for use in performing frictionless custody chain management, specifically for initiating transmission of a custody transfer request data object to cause storing of a new transfer record when the user (e.g., a recipient user) received a transfer item during a transaction (e.g., a sale of a transfer item, transfer of a transfer item, gift of a transfer item, or the like).

At block 902, the apparatus 200B includes means, such as capture management module 210B, custody transfer request module 212B, processor 202B, input/output module 206B, communications module 208B, and/or the like, or a combination thereof, to receive user transfer request information in response to user engagement. In some embodiments, the user engagement may embody manual input of the user transfer request information. For example, the user may, via the apparatus 200B, type, speak, or otherwise engage with the apparatus 200B to manually input information associated with a transfer item (e.g., to select and/or input an associated transfer item data object, or to select and/or input associated transfer item data object identification information) and/or information associated with a transferor data object (e.g., to select and/or input an associated transferor data object, or to select and/or input associated transferor identification information).

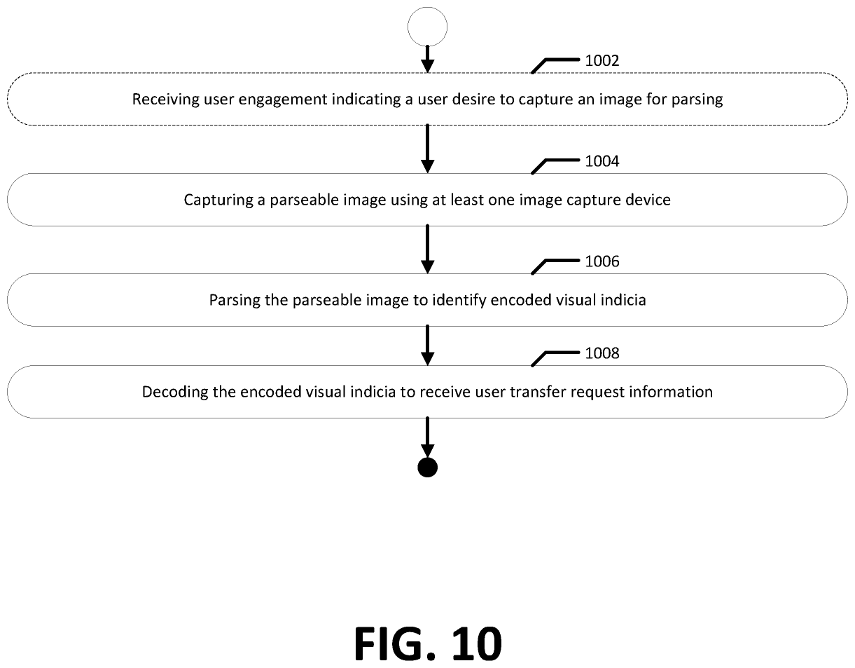

In some embodiments, the user engagement may be associated with receiving and/or capturing a parseable image for processing to receive associated user transfer request information. In this regard, for example, the user transfer request information may be received as described below with respect to FIG. 10. It should be appreciated that, in some embodiments, a portion of the user transfer request information may be manually input by a user, and a second portion of the user transfer request information may be automatically identified, parsed, and/or decoded from a captured parseable image. For example, in some embodiments, a transfer item data object (or associated identification information) may be received based on a captured parseable image, and a transferor data object (or associated identification information) may be received via manual input by a user.

In some embodiments, the apparatus 200B may be configured, using such components, to render an interface to receive the user transfer request information. In this regard, the interface may include one or more interface components for receiving at least a transfer item data object, or transfer item data object identification information, manually input by the user. Additionally or alternatively, the interface may include interface components for inputting a transferor data object, or corresponding identification information, or any additional information associated with the transfer.

At block 904, the apparatus 200B includes means, such as capture management module 210B, custody transfer request module 212B, processor 202B, and/or the like, or a combination thereof, to identify a transfer request destination URL associated with the user transfer request information. The transfer request destination URL may represent an endpoint in the network system for which information, such as a generated custody transfer request data object, should be transmitted to for processing. For example, in some embodiments, the apparatus 200B may parse the transfer request destination URL from the user transfer request information. In this regard, for example, a transfer request destination URL may be customized based on the transfer item data object associated with the user transfer request information. Alternatively, in some embodiments, the apparatus 200B may be configured to identify a pre-determined transfer request destination URL. In some such embodiments, the apparatus 200B may utilize the user transfer request information, or a portion thereof, to differentiate between transfer of different transfer items when transmitting to the pre-determined transfer request destination URL.

At block 906, the apparatus 200B includes means, such as custody transfer request module 212B, processor 202B, input/output module 206B, communications module 208B, and/or the like, or a combination thereof, to access transfer request destination URL. In some embodiments, the transfer request destination URL is accessed via user engagement by the user of the apparatus 200B. For example, the apparatus 200B may receive user engagement for accessing the transfer request destination URL and generating and/or transmitting corresponding information for processing. In some such embodiments, the transfer request destination URL may embody an endpoint at a network device, and configured to forward the transmitted information to another device, such as a custody management system. In some other embodiments, the transfer request destination URL may embody an endpoint at a device within a custody management system.

At optional block 908, the apparatus 200B includes means, such as custody transfer request module 212B, processor 202B, communications module 208B, and/or the like, or a combination thereof, to cause transmission of device identification information to an authentication system. In some embodiments, to cause transmission of the device identification information to the authentication system, the apparatus 200B is configured to generate and/or transmit a custody transfer request data object, and/or other information, over a communications network to a device associated with the transfer request destination URL. In some such embodiments, the device identification information may be injected, by a network device of the communications network for example, into the transmission from the apparatus 200B, for example using a header enrichment process. In a particular example, the transfer request destination URL may represent a particular endpoint network device of a carrier network associated with the apparatus 200B embodying a mobile device, such that the network device is configured to inject the mobile phone number associated with the mobile device into the transmission before forwarding it to the authentication system.

It should be appreciated that, in some embodiments, the authentication system is a sub-system of a custody management system. Alternatively, in other embodiments, the authentication system is separate from the custody management system, and is communicable with the custody management system to perform one or more authentication process(es) and transmit one or more signals indicating the results of the authentication processes. In this regard, the authentication system may be configured to receive device identification information and/or other information, such as information and/or data used in one or more authentication processes, directly from the apparatus 200B over a communications network, and authenticate such information using the one or more authentication processes. In yet other embodiments, the authentication system may receive the device identification information, and/or other transmitted information, indirectly via the custody management system. For example, in some embodiments, the apparatus 200B may cause transmission of device identification information to the custody management system for processing and/or forwarding to the authentication system. In other embodiments, the custody management system, for example embodied by the apparatus 200A, embodies the authentication system, such that no forwarding is required.

At block 910, the apparatus 200B includes means, such as custody transfer request module 212B, processor 202B, communications module 208B, and/or the like, or a combination thereof, to provide a custody transfer request data object associated with the user transfer request information to a custody management system. For example, in some embodiments, the apparatus 200B is configured to configure and/or generate the custody transfer request data object based on the user transfer request information. For example, the custody transfer request data object may include at least transfer item data object identification information and/or transferor data object identification information. In yet other embodiments, the apparatus 200B may include additional and/or alternative data and/or information in the custody transfer request data object that may be included in and/or used in creating a corresponding transfer record.

In some embodiments, the custody transfer request data object is provided to the custody management system over a communications network. For example, the custody transfer request data object may be transmitted over the communications network to a particular device, system, and/or the like, associated with the transfer request destination URL. In some such embodiments, the transfer request destination URL represents an endpoint at a network device of the communications network, where the network device is configured to forward the custody transfer request data object to the custody management system (for example, after performing a header enrichment process to inject device identification information). In other embodiments, the transfer request destination URL represents an endpoint at the custody management system, or a sub-system thereof, such that no forwarding is required.

In response to receiving the custody transfer request data object, the custody management system may process the custody transfer request data object. For example, in some embodiments, the custody management system alone or in conjunction with an authentication system may perform one or more authentication processes based on information associated with and/or provided in the custody transfer request data object. Additionally or alternatively, the custody management system may process the custody transfer request data object to generate and/or store a new transfer record associated with the custody transfer request data object. For example, the custody management system may store a new transfer record associated with the custody transfer request data object to a transfer record blockchain.

At optional block 912, the apparatus 200B includes means, such as custody transfer request module 212B, processor 202B, input/output module 206B, communications module 208B, and/or the like, or a combination thereof, to receive a custody transfer response data object from the custody management system. In an example context, the custody transfer response data object may comprise a transfer denial error where one or more authentication processes performed by the custody management system and/or an associated authentication system failed. In another example context, the custody transfer response data object may indicate that processing the custody transfer request data object was successfully performed. For example, the custody transfer response data object may include information identifying the newly stored transfer record (e.g., a block hash and/or other identifier).

In some such embodiments, such means may further be configured to perform one or more actions based on the received custody transfer response data object. For example, in some embodiments, the apparatus 200B may output one or more associated interfaces for rendering. Such interfaces may be configured to display, to a user for example, whether the custody transfer request data object was successfully processed. Alternatively, the apparatus 200B may transmit one or more notification messages in response to a custody transfer response data object embodying or including a transfer denial error. Such notification messages may be transmitted to one or more client devices indicating that a fraudulent transfer was initiated, and in some embodiments may provide device identification information identifying the unauthenticated party (e.g., the transferor user or the recipient user).

FIG. 10 illustrates one example process for receiving user transfer request information that may be used in some embodiments to facilitate frictionless custody chain management. For example, in some embodiments, the process described with respect to FIG. 10 may embody a sub-process for facilitating frictionless custody chain management, for example at block 902 of the process depicted with respect to FIG. 9. It should be understood that, in some embodiments, the process described with respect to FIG. 10 may be combined with other processes with associated operations performed in any combination, order, and/or the like. The example process may provide a specific computer-implemented method to be performed by specially configured hardware and/or software, for example performed by the apparatus 200B in conjunction with one or more other processes.

At optional block 1002, the apparatus 200B includes means, such as capture management module 210B, custody transfer request module 212B, input/output module 206B, communications module 208B, processor 202B, and/or the like, or a combination thereof, to receive user engagement indicating a user desire to capture an image for parsing. In this regard, the user engagement may be associated with activating one or more components of the apparatus 200B, such as one or more image capture devices, cameras, sensors, and/or the like. It should be appreciated that any of a myriad of user engagement types may be received. For example, a user may perform a tap, click, button press, key press, gesture, voice command, eye command, motion control, and/or the like specifically associated with capturing an image. In yet some embodiments, the apparatus 200B may detect a parseable image upon movement by the user, such that the movement functions as the user engagement to automatically capture the parseable image without subsequent user engagement. In some embodiments, the user engagement may be received by a specially executed service application executed via the apparatus 200B.

At block 1004, the apparatus 200B includes means, such as capture management module 210B, custody transfer request module 212B, input/output module 206B, communications module 208B, processor 202B, and/or the like, or a combination thereof, to capture a parseable image using at least one image capture device. The apparatus 200B may capture the parseable image in response to the received user input. In some embodiments, the at least one capture device comprises at least one camera associated with the apparatus 200B. The parseable image may be captured by the camera(s) for further processing by the apparatus 200B.

The parseable image may include visual indicia detectable, parseable, and/or decodable by the apparatus 200B to receive associated user transfer request information. For example, in some embodiments, the parseable image comprises a QR code, barcode, parseable text, encoded image, and/or the like. In some embodiments, the parseable image includes one or more sub-parseable images, for example a QR code and a barcode. In some such embodiments, the sub-parseable images may each include a portion of information to be combined to form the complete user transfer request information.

The parseable image may be printed, imprinted, etched into, and/or otherwise physically presented on a particular transfer item with which the parseable image is associated. Alternatively or additionally, the parseable image may be provided associated with a transfer item, for example on a tag, wearable item (e.g., a wristband, watch, necklace, or the like), instruction manual or other material provided along with the transfer item, or the like. In some such embodiments, the parseable image may be captured along with the transfer item as the transfer item is transferred between users.

At block 1006, the apparatus 200B includes means, such as capture management module 210B, custody transfer request module 212B, processor 202B, and/or the like, or a combination thereof, to parse the parseable image to identify encoded visual indicia. In some such embodiments, the apparatus 200B is configured to parse the parseable image using one or more parsing methodologies. The parsing methodologies may isolate the encoded visual indicia from the parseable image, and extract it for analysis. For example, the encoded visual indicia may be designed to be detected from within the captured parseable image and parsed therefrom. It should be appreciated that, in some embodiments, the encoded visual indicia is parsed automatically by the apparatus 200B. In some embodiments, the encoded visual indicia is parsed using at least one manual step by the user of the apparatus 200B (for example, to isolate the encoded visual indicia from the parseable image). Non-limiting examples of encoded visual indicia include a QR code, barcode, encoded pattern, color-encoded pattern, and/or the like.

At block 1008, the apparatus 200B includes means, such as capture management module 210B, custody transfer request module 212B, processor 202B, and/or the like, or a combination thereof, configured to decode the encoded visual indicia to receive user transfer request information. For example, the user transfer request information may include data used for generating and/or transmitting a custody transfer request data object. The user transfer request information may include, for example and without limitation, at least a transfer item data object (or corresponding transfer item data object identification information) associated with the transfer item. Additionally or alternatively, in some embodiments, the user transfer request information may include a transfer request destination URL. Additionally or alternatively, in some embodiments, the user transfer request information may include a transferor data object (or corresponding transferor data object identification information).

In some embodiments, the user transfer request information may be encrypted. In some such embodiments, the apparatus 200B may be configured to decrypt the user transfer request information before use. For example, the apparatus 200B may be configured to apply the encrypted user transfer request information to one or more decryption algorithms. In yet other embodiments, the apparatus 200B may leave the user transfer request information encrypted for transmission to the custody management system and/or authentication system for decryption and/or comparison.

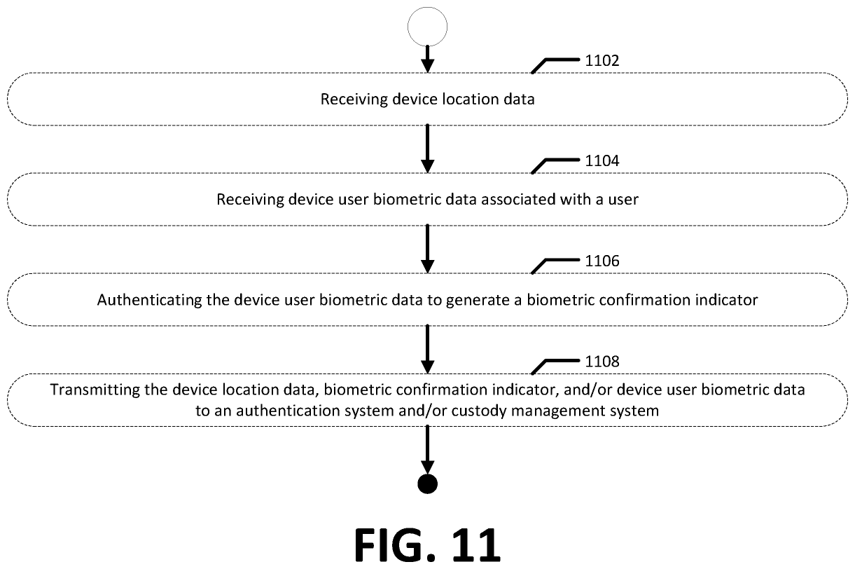

FIG. 11 illustrates one example process for user authentication at a client device that may be used in some embodiments to facilitate frictionless custody chain management. For example, in some embodiments, the process described with respect to FIG. 11 may embody a sub-process for facilitating frictionless custody chain management, for example as additional or alternative operations to the process depicted with respect to FIG. 9. It should be understood that, in some embodiments, the process described with respect to FIG. 11 may be combined with other processes with associated operations performed in any combination, order, and/or the like. The example process may provide a specific computer-implemented method to be performed by specially configured hardware and/or software, for example performed by the apparatus 200B in conjunction with one or more other processes.

At optional block 1102, the apparatus 200B includes means, such as the capture management module 210B, custody transfer request module 212B, input/output module 206B, communications module 208B, processor 202B, and/or the like, or a combination thereof, to receive device location data. In some embodiments, such means include location services hardware (e.g., GPS, one or more triangulation units, or the like) for receiving the device location data. In other embodiments, the device location data may be received in response to user input, for example from a user of the apparatus 200B. Additionally or alternatively, in some embodiments, the apparatus 200B may receive some or all of the device location data by retrieving the device location data from a database managed by the apparatus 200B. It should be appreciated that the device location data may be received in a variety of formats (e.g., a GPS coordinate, latitude and longitude coordinate, a region designation, address, zip code, and/or the like). The device location data may indicate a current location of the user and/or apparatus 200B.

At optional block 1104, the apparatus 200B includes means, such as the capture management module 210B, custody transfer request module 212B, input/output module 206B, communications module 208B, processor 202B, and/or the like, or a combination thereof, to receive device user biometric data associated with the user. In some such embodiments, such means include one or more scanning and/or detection components, hardware, circuitry, and/or the like, each configured for receiving one or more type of biometric data. For example, the apparatus 200B may include a fingerprint scanner, face scanner, iris scanner, walking gait scanner, microphone, and/or the like, or a combination thereof, to receive the device user biometric data. The user of the apparatus 200B may engage with one or more of these components to prompt receiving of the device user biometric data. Alternatively or additionally, in some embodiments, the apparatus 200B may receive some or all of the device user biometric data by retrieving it from a database managed by the apparatus 200B.

At optional block 1106, the apparatus 200B includes means, such as the custody transfer request module 212B, processor 202B, and/or the like, or a combination thereof, to authenticate the device user biometric data to generate a biometric confirmation indicator. For example, the apparatus 200B may compare the device user biometric data received to one or more instances of stored confirm biometric data. The stored confirmed biometric data may have been provisioned and/or configured from the user at an earlier time, for example during installation of a specially configured service app and/or during setup and/or configuration of the apparatus 200B. In some embodiments, the apparatus 200B may leverage one or more APIs to perform the authentication of the device user biometric data. For example, the apparatus 200B may access one or more operating system APIs provided by the operating system of the apparatus 200B to securely authenticate the device user biometric data. The biometric confirmation indicator may represent the results of the authentication. For example, the biometric confirmation indicator may embody a first value indicating the authentication failed (e.g., a false Boolean data value, a 0 integer value, a string indicating failed, and/or the like), or a second value indicating the authentication succeeded (e.g., a true Boolean data value, a 1 integer value, a string indicating success, and/or the like).

At optional block 1108, the apparatus 200B includes means, such as the capture management module 210B, custody transfer request module 212B, input/output module 206B, communications module 208B, processor 202B, and/or the like, or a combination thereof, to transmit the device location data, biometric confirmation indicator, and/or device user biometric data to an authentication system and/or a custody management system. In some embodiments, either the device user biometric data or the biometric confirmation indicator may be transmitted, but not both. The apparatus 200B may include each data in a custody transfer request data object that is transmitted to the authentication system and/or custody management system, either directly or indirectly. The transmitted device location data, biometric confirmation indicator, and/or device user biometric data may be used to perform one or more authentication processes.

In some embodiments, for example where the operations depicted with respect to FIG. 11 are a sub-process, processing of another line of operations may continue after block 1108. For example, in embodiments where the operations depicted with respect to FIG. 11 are additionally and/or alternatively included with one or more of the operations described with respect to FIG. 9, one or more operations of FIG. 9 may continue upon completion of operation 1108. Alternatively, in some embodiments, the authentication system and/or custody management system may proceed with analyzing data transmitted to it, for example a custody transfer request data object including the device location data, biometric confirmation indicator, and//or device user biometric data, and the flow may end after block 1108.

### CONCLUSION

In some embodiments, some of the operations above may be modified or further amplified. Furthermore, in some embodiments, additional optional operations may be included. Modifications, amplifications, or additions to the operations above may be performed in any order and in any combination.

Many modifications and other embodiments of the disclosure set forth herein will come to mind to one skilled in the art to which this disclosure pertains having the benefit of the teachings presented in the foregoing description and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus for frictionless custody chain management, the apparatus comprising at least one processor and at least one memory, the at least one memory having computer-coded instructions thereon, the computer-coded instructions configured to, in execution with the at least one processor, configure the apparatus to:
receive, from a recipient client device, a custody transfer request data object comprising transfer request information;
identify device identification information associated with the recipient client device;
associate at least the device identification information with a transfer item data object to identify an associated transfer information set; and
store, to a transfer record storage, a transfer record comprising the associated transfer information set.

2. The apparatus of claim 1, wherein the device identification information associated with the recipient client device is identified from a network device associated with a trusted network provider using a header enrichment process.

3. The apparatus of claim 1, wherein the custody transfer request data object further comprises device location data associated with the recipient client device, and wherein the apparatus is further configured to:
identify stored proximity data associated with the recipient client device; and
compare the device location data and the stored proximity data to determine whether the device location data is within a geographic region defined by the stored proximity data.

4. The apparatus of claim 1, wherein the custody transfer request data object further comprises device user biometric data, and wherein the apparatus is further configured to:
identify confirmed biometric data associated with the recipient client device; and
compare the device user biometric data and the confirmed biometric data to determine whether the device user biometric data matches the confirmed biometric data.

5. The apparatus of claim 1, wherein the transfer request information comprises a transfer item data object and transferor data object identification information associated with a transferor data object, and wherein the apparatus is further configured to:
query the transfer record blockchain, based on the transfer data object, to identify a recorded possessor data object associated with the transfer item data object;
receive result data including the recorded possessor data object associated with the transfer item data object; and
determine the recorded possessor data object matches the transferor data object.

6. The apparatus of claim 1, wherein the custody transfer request data object further comprises device location data associated with the recipient client device, and wherein the apparatus is further configured to:
identify stored proximity data associated with the recipient client device;
compare the device location data and the stored proximity data to determine the device location data is not within a geographic region defined by the stored proximity data; and
transmit a transfer denial error to the recipient client device in response to the determination.

7. The apparatus of claim 1, wherein the custody transfer request data object further comprises device user biometric data, and wherein the apparatus is configured to:
identify confirmed biometric data associated with the recipient client device;
compare the device user biometric data and the confirmed biometric data determine the device user biometric data does not match the confirmed biometric data; and
transmit a transfer denial error to the recipient client device in response to the determination.

8. The apparatus of claim 1, wherein the transfer request information comprises a transfer item data object and transferor data object identification information associated with a transferor data object, and wherein the apparatus is further configured to:
query the transfer record blockchain, based on the transfer data object, to identify a recorded possessor data object associated with the transfer item data object;
receive result data including the recorded possessor data object associated with the transfer item data object;
determine the recorded possessor data object does not match the transferor data object; and
transmit a transfer denial error to the recipient client device in response to the determination.

9. The apparatus of claim 1, wherein the transfer request information comprises a transferor user authentication information associated with a transferor data object, and wherein the apparatus is further configured to:
authenticate the transferor user authentication information based on stored authentication information associated with the transferor data object.

10. The apparatus of claim 1, wherein the associated transfer information set comprises (1) the device identification information, (2) transferor data object identification information associated with a transferor data object, (3) transfer item information associated with a transfer item data object, (4) a transfer timestamp, (5) image data associated with the transfer request information, or (6) a combination thereof.

11. An computer-implemented method for frictionless custody chain management, the method comprising:
receiving, from a recipient client device, a custody transfer request data object comprising transfer request information;
identifying device identification information associated with the recipient client device;
associating at least the device identification information with a transfer item data object to identify an associated transfer information set; and
storing, to a transfer record storage, a transfer record comprising the associated transfer information set.

12. The method of claim 11, wherein the device identification information associated with the recipient client device is identified from a network device associated with a trusted network provider using a header enrichment process.

13. The method of claim 11, wherein the custody transfer request data object further comprises device location data associated with the recipient client device, and the method further comprising:
identifying stored proximity data associated with the recipient client device; and
comparing the device location data and the stored proximity data to determine whether the device location data is within a geographic region defined by the stored proximity data.

14. The method of claim 11, wherein the custody transfer request data object further comprises device user biometric data, and the method further comprising:
identifying confirmed biometric data associated with the recipient client device; and
comparing the device user biometric data and the confirmed biometric data to determine whether the device user biometric data matches the confirmed biometric data.

15. The method of claim 11, wherein the transfer request information comprises a transfer item data object and transferor data object identification information associated with a transferor data object, and the method further comprising:
querying the transfer record blockchain, based on the transfer data object, to identify a recorded possessor data object associated with the transfer item data object;
receiving result data including the recorded possessor data object associated with the transfer item data object; and
determining the recorded possessor data object matches the transferor data object.

16. The method of claim 11, wherein the custody transfer request data object further comprises device location data associated with the recipient client device, and the method further comprising:
identifying stored proximity data associated with the recipient client device;
comparing the device location data and the stored proximity data to determine the device location data is not within a geographic region defined by the stored proximity data; and
transmitting a transfer denial error to the recipient client device in response to the determination.

17. (canceled)

18. The method of claim 11, wherein the transfer request information comprises a transfer item data object and transferor data object identification information associated with a transferor data object, and the method further comprising:
querying the transfer record blockchain, based on the transfer data object, to identify a recorded possessor data object associated with the transfer item data object;
receiving result data including the recorded possessor data object associated with the transfer item data object;
determining the recorded possessor data object does not match the transferor data object; and
transmitting a transfer denial error to the recipient client device in response to the determination.

19. The method of claim 11, wherein the transfer request information comprises a transferor user authentication information associated with a transferor data object, and the method further comprising:
authenticating the transferor user authentication information based on stored authentication information associated with the transferor data object.

20. The method of claim 11, wherein the associated transfer information set comprises (1) the device identification information, (2) transferor data object identification information associated with a transferor data object, (3) transfer item information associated with a transfer item data object, (4) a transfer timestamp, (5) image data associated with the transfer request information, or (6) a combination thereof.

21. A computer program product for frictionless custody chain management, the computer program product comprising a non-transitory computer readable storage medium having computer program instructions stored thereon, the computer program instructions, when executed by a processor, configured for:
receiving, from a recipient client device, a custody transfer request data object comprising transfer request information;
identifying device identification information associated with the recipient client device;
associating at least the device identification information with a transfer item data object to identify an associated transfer information set; and
storing, to a transfer record storage, a transfer record comprising the associated transfer information set.

22-51. (canceled)
